(19) United States
(12) Patent Application Publication
(10) Pub. No.: US 2016/0210666 A1
(43) Pub. Date: Jul. 21, 2016

(54) DELIVERY DEVICE, TERMINAL DEVICE, DELIVERY METHOD, AND NON-TRANSITORY COMPUTER READABLE STORAGE MEDIUM

(71) Applicant: YAHOO JAPAN CORPORATION, Tokyo (JP)

(72) Inventors: Kazuto ATAKA, Tokyo (JP); Toru TAKATA, Tokyo (JP); Masatsugu SHIDACHI, Tokyo (JP); Nari WOO, Tokyo (JP); Yuki TAKI, Tokyo (JP); Naoya KURITA, Tokyo (JP)

(73) Assignee: YAHOO JAPAN CORPORATION, Tokyo (JP)

(21) Appl. No.: 14/988,287

(22) Filed: Jan. 5, 2016

(30) Foreign Application Priority Data
Jan. 20, 2015 (JP) 2015-008873

(51) Int. Cl. G06Q 30/02; G06F 17/21; G06F 17/22; G06T 3/40

(52) U.S. Cl. CPC G06Q 30/0255; G06T 3/40; G06F 17/212; G06F 17/2247; G06Q 30/0275; G06Q 30/0277

(57) ABSTRACT

A delivery device according to the invention includes a delivering unit, which delivers control information to a terminal device that includes a display unit. The control information makes the terminal device to perform display control for controlling the display format of an advertising content having a bigger display size than size of the display unit. As a result, the delivery device according to the invention can enhance the advertisement effectiveness of the advertising content.

### CROSS-REFERENCE TO RELATED APPLICATION(S)

The present application claims priority to and incorporates by reference the entire contents of Japanese Patent Application No. 2015-008873 filed in Japan on Jan. 20, 2015.

### BACKGROUND OF THE INVENTION

1. Field of the Invention

The present invention relates to a delivery device, a terminal device, a delivery method, and a non-transitory computer readable storage medium.

2. Description of the Related Art

In recent years, with the exponential gain in popularity of the Internet, advertisement delivery via the Internet is being actively pursued. For example, when advertising spaces representing display areas for advertising contents are provided in a page, a terminal device obtains an advertising content for each advertising space from an advertisement delivery device, and displays the advertising content in the corresponding advertising space.

A technology is known in which images displayed on a terminal device can be moved, enlarged, or reduced by performing intuitive operations with respect to the terminal device (for example, Japan Laid-open Patent Publication No. 2011-248811). Moreover, a technology is known by which the hand in which a terminal device is held can be used to issue instructions to change the display contents or perform various inputs with ease (for example, Japanese Laid-open Patent Publication No. 6-4208).

For example, in Japan Patent Application Laid-open No. 2011-248811, it is disclosed that, when a handheld terminal is moved by a user, the movement of the handheld terminal is detected using an acceleration sensor, and moving the display position of an image and enlarging/reducing the image is done according to the movement of the handheld terminal.

In Japanese Laid-open Patent Publication No. 6-4208, it is disclosed that the acceleration of a terminal device that is operated with one hand is detected, and the display contents are controlled based on the amount of movement of the terminal device as obtained from the detected acceleration value.

However, in the conventional technology, it is not necessarily possible to enhance the advertisement effectiveness. For example, the conventional technology is meant only for enhancing the operability of the user with respect to the terminal device. Hence, it is not necessarily possible to enhance the advertisement effectiveness of the advertising contents.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of an advertisement operation according to an embodiment;

FIG. 2 is a diagram illustrating an exemplary configuration of an advertisement system according to the embodiment;

FIG. 3 is a diagram illustrating an exemplary configuration of a terminal device according to the embodiment;

FIG. 4 is a diagram for explaining about an aspect of the size of an advertising content with respect to a display unit and about the position of placement of an advertising space in a webpage;

FIG. 5 is a diagram illustrating an example of a display rate obtaining operation;

FIG. 6 is a diagram illustrating an exemplary configuration of an advertisement server device according to the embodiment;

FIG. 7 is a diagram illustrating an example of an advertising content storing unit according to the embodiment;

FIG. 8 is a diagram illustrating an example of a browsing behavior storing unit according to the embodiment;

FIG. 9 is a sequence diagram illustrating a sequence of operations during an advertisement operation performed in the advertisement system according to the embodiment;

FIG. 10 is a diagram illustrating an exemplary configuration of an advertisement server device according to a modification example;

FIG. 11 is a diagram illustrating an example of an advertising content storing unit according to a modification example;

FIG. 12 is a diagram illustrating an example of the display control performed in the case of displaying a relevant content in an overlapping manner on an advertising content;

FIG. 13 is a diagram illustrating an example of the display format in the case of displaying a relevant content in an overlapping manner on an advertising content;

FIG. 14 is a diagram illustrating a configuration of an advertisement server device according to a modification example;

FIG. 15 is a diagram illustrating an example of an advertising content storing unit according to a modification example;

FIG. 16 is a diagram for explaining the display control performed to display a webpage in a transparently overlapping manner on an advertising content; and

FIG. 17 is a diagram illustrating an exemplary hardware configuration of a computer that implements the functions of the terminal device.

### DETAILED DESCRIPTION OF THE PREFERRED EMBODIMENTS

An exemplary embodiment of a delivery device, a terminal device, a delivery method, and a non-transitory computer readable storage medium according to the present invention is described in detail below with reference to the accompanying drawings. The delivery device, the terminal device, the delivery method, and the computer program product according to the present invention are not limited to these exemplary embodiments. Moreover, in the following embodiments, identical constituent elements are referred to by the same reference numerals and the redundant explanation is not repeated.

### 1. ADVERTISEMENT OPERATION

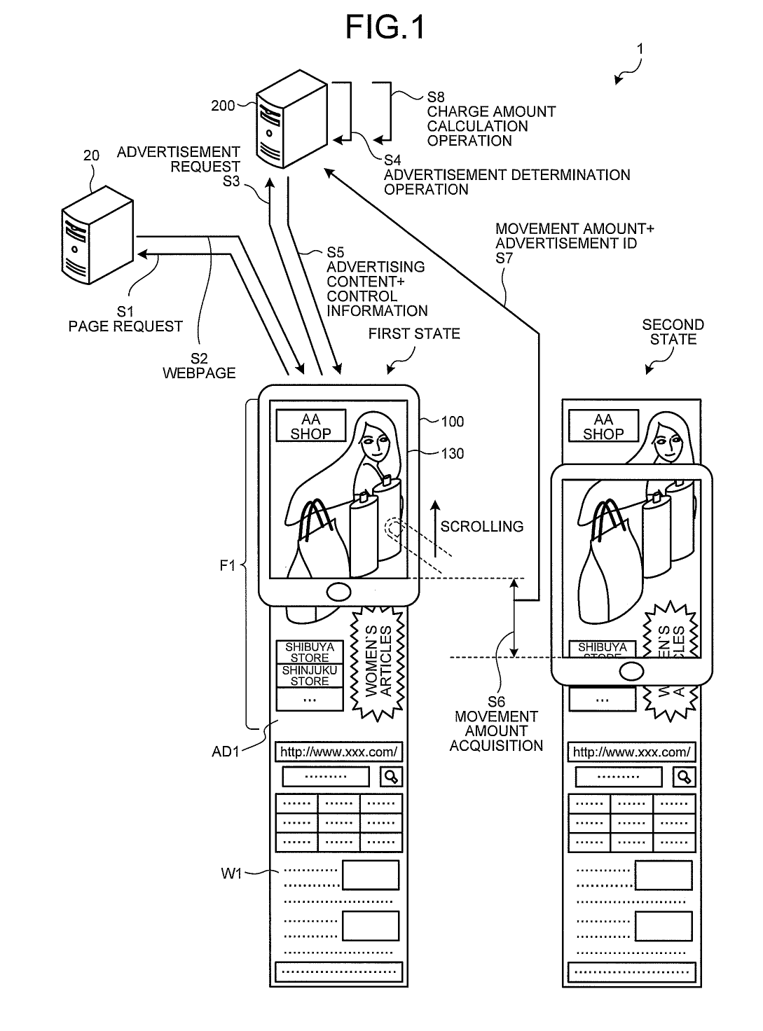

Firstly, explained with reference to FIG. 1 is an example of a display operation that represents a part of an advertisement operation according to the embodiment. FIG. 1 is a diagram illustrating an example of the advertisement operation according to the embodiment. In the example illustrated in FIG. 1, an advertisement system 1 includes a contents server device 20, a terminal device 100, and an advertisement server device 200.

The contents server device 20 delivers, to the terminal device 100 in response to a request issued by the terminal device 100, contents such as webpages that include advertising spaces for displaying advertising contents. The advertisement server device 200 sends advertising contents to the terminal device 100 in response to a request issued by the terminal device 100.

Given below is the explanation about the advertising contents according to the present embodiment. In the present embodiment, the advertising contents are displayed to be bigger than the size of a display unit 130 of the terminal device 100 (described later). For example, the advertising contents are displayed to be vertically longer than the vertical size of the display unit 130. Alternatively, the advertising contents are displayed to be horizontally longer than the horizontal size of the display unit 130.

The terminal device 100 is a terminal device such as a smartphone. The terminal device 100 includes the display unit 130 such as a liquid crystal display. Thus, the terminal device 100 performs display control so that contents received from the contents server device 20 and advertising contents received from the advertisement server device 200 are displayed on the display unit 130.

Given below is the explanation about the flow of operations that are performed in the advertisement system 1. Firstly, according to a user operation, the terminal device 100 sends a page request for requesting a webpage W1 to the contents server device 20 (Step S1).

In response to the page request received from the terminal device 100, the contents server device 20 delivers the webpage W1, which includes an advertising space F1, to the terminal device 100 (Step S2). Upon receiving the web page W1 from the contents server device 20; since the web page W1 includes the advertising space F1, the terminal device 100 sends an advertisement request, which is a request for delivering the advertising content to be put in the advertising space F1, to the advertisement server device 200 (Step S3).

Upon receiving the advertisement request from the terminal device 100, the advertisement server device 200 performs a determination operation for determining the advertising content that is to be delivered to the terminal device 100 in response to the advertisement request (Step S4). For example, based on bid information received from the advertiser who represents the source of submission of the advertising content, the advertisement server device 200 determines the advertising content that is to be delivered. Herein, assume that the advertisement server device 200 determines an advertising content AD1 as the target for delivery. Then, the advertisement server device 200 delivers the advertising content AD1 and control information to the terminal device 100 (Step S5).

The control information represents, for example, a computer program written in JavaScript (registered trademark), and represents a control program for instructing the terminal device 100 to perform a variety of display control with respect to the advertising content received from the advertisement server device 200 and to obtain information related to the browsing behavior of the user and information related to the user operations.

Upon receiving the advertising content AD1 from the advertisement server device 200; the terminal device 100 displays, on the display unit 130, the webpage W1 in which the advertising content AD1 is put in the advertising space F1. In the example illustrated in FIG. 1, since the advertising space F1 is positioned at the upper end of the webpage W1, the terminal device 100 displays the advertising content AD1 in the first place (i.e., performs initial display). The state of the initial display in which the advertising content AD1 is displayed by the terminal device 100 is called a first state.

Moreover, as described earlier, the advertising content AD1 is displayed to be bigger than the size of the display unit 130 of the terminal device 100. That is, the advertising content AD1 that is bigger than the size of the display unit 130 is placed on the webpage W1, so that the advertising content AD1 gets displayed to be bigger than the size of the display unit 130. For that reason, only some part of the advertising content AD1 gets displayed on the display unit 130. In FIG. 1 is illustrated an example in which the advertising content AD1 that is displayed is vertically longer than the vertical size of the display unit 130 but has the same horizontal size as the horizontal size of the display unit 130.

Given below is the explanation of a charging operation that represents a part of the advertisement operation and that is performed by the advertisement server device 200 for charging the advertisers. The administrator of the advertisement server device 200 uses the advertisement server device 200 to deliver an advertising content, which is displayed to be bigger than the size of the display unit 130 of the terminal device 100, to the terminal device 100 and attempts to enhance the advertising effectiveness of the concerned advertising content. Then, the administrator of the advertisement server device 200 uses the advertisement server device 200 and charges the advertiser based on user browsing and operation information with respect to the advertising content.

As described earlier, the control information is used to make the terminal device 100 not only to perform a variety of display control with respect to the advertising content but also to obtain information related to the browsing behavior of the user with respect to the advertising content and information related to the user operations.

Given below is the explanation of an exemplary operation by which the advertisement server device 200 calculates the charge amount according to the amount of movement of the advertising content attributed to scrolling (hereinafter, sometimes written as “movement amount”) that represents information related to user operations performed with respect to the advertising content obtained by the terminal device 100.

Firstly, assume that the display state of the display unit 130 is in the first state illustrated in FIG. 1. Moreover, assume that the user performs upward scrolling on the display unit 130, so that the display state of the display unit 130 changes to a second state illustrated in FIG. 1.

At that time, according to the instruction specified in the control information, the terminal device 100 obtains the movement amount representing the amount by which the advertising content is moved in the display unit 130 due to scrolling (Step S6). Then, the terminal device 100 sends, to the advertisement server device 200, the movement amount in a corresponding manner to an advertisement ID representing identification information of the advertising content AD1 (Step S7).

The advertisement server device 200 performs a calculation operation for calculating the charge amount based on the movement amount received from the terminal device 100 (Step S8). Then, for example, the advertisement server device 200 refers to the advertisement ID of the advertising content AD1 and sends the charge amount to the terminal device of the advertiser of the advertising content AD1. That marks the end of the charging operation.

In this way, according to the embodiment, the advertisement server device 200 delivers control information to the terminal device 100 and instructs the terminal device 100 to display the advertising content to be bigger than the size of the display unit 130. That enables the advertisement server device 200 to make the user to gaze at the advertising content thereby boosting his or her interest in the advertising content. As a result, the advertising effectiveness of the concerned advertising content can be enhanced. Moreover, the control information makes the terminal device 100 to obtain the movement amount attributed to scrolling of the advertising content that is displayed to be bigger than the size of the display unit 130. Hence, even when the advertising content is displayed to be bigger than the size of the display unit 130, the advertisement server device 200 can calculate a fair charge amount with respect to the advertiser.

### 2. ADVERTISEMENT SYSTEM

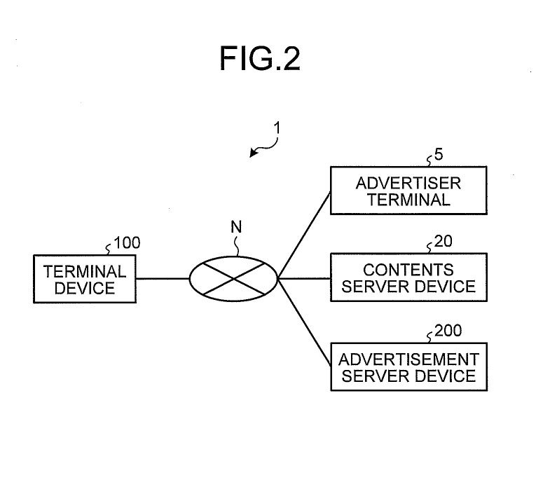

Explained below with reference to FIG. 2 is a configuration of the advertisement system according to the embodiment. FIG. 2 is a diagram illustrating an exemplary configuration of the advertisement system 1 according to the embodiment. As illustrated in FIG. 2, the advertisement system 1 includes an advertiser terminal 5, the contents server device 20, the terminal device 100, and the advertisement server device 200. Herein, the advertiser terminal 5, the contents server device 20, the terminal device 100, and the advertisement server device 200 are communicably connected in a wired or wireless manner via a network N. Meanwhile, in the advertisement system 1 illustrated in FIG. 2, it is possible to install a plurality of advertiser terminals 5, a plurality of contents server devices 20, a plurality of terminal devices 100, or a plurality of advertisement server devices 200.

The advertiser terminal 5 is an information processing device used by an advertiser. For example, the advertiser terminal 5 is a desktop personal computer (PC), a tablet PC, a laptop PC, a tablet terminal, a cellular phone, or a personal digital assistant (PDA). In response to an operation performed by the advertiser, the advertiser terminal 5 submits an advertising content to the advertisement server device 200. For example, the advertiser terminal 5 submits, to the advertisement server device 200, an advertising content in the form of a still image, a moving image, text data, or a uniform resource locator (URL) that enables accessing the advertiser page managed by the advertiser and delivered by an advertiser server.

Meanwhile, there are times when an advertiser requests an advertisement agency to submit an advertising content. In such a case, it is the advertisement agency that submits the advertising content to the advertisement server device 200. Thus, in the following explanation, the term “advertiser” includes the concept of not only an advertiser but also of an advertising agency, and the term “advertiser terminal” includes the concept of not only the advertiser terminal 5 but also of an advertisement agency device used by an advertisement agency.

The contents server device 20 is a webserver for delivering contents such as webpages to the terminal device 100. For example, the contents server device 20 delivers various webpages related to news sites, auction sites, weather forecasting sites, shopping sites, finance (share market) sites, route searching sites, map providing sites, travel sites, restaurant referral sites, web blogs, and so on.

The webpages delivered by the contents server device 20 are, for example, formed as HTML files written in the hypertext markup language (HTML) or as XML files written in the extensible markup language (XML). Moreover, the webpages delivered by the contents server device 20 have predetermined advertising spaces provided therein, and include advertisement acquisition instructions to be put in the advertising spaces. For example, in an HTML file constituting a webpage, the URL of the advertisement server device 200 is written as an advertisement acquisition instruction. In that case, the terminal device 100 accesses the URL written in the concerned HTML file, and obtains an advertising content from the advertisement server device 200.

Meanwhile, a variety of data that is delivered from the contents server device 20 to the terminal device 100 is actually in the form of HTML files and images constituting a webpage. Thus, in the following explanation, a variety of data that is delivered from the contents server device 20 to the terminal device 100 is sometimes written as “webpage”.

The terminal device 100 is an information processing device used by a user. For example, the terminal device 100 is a desktop PC, a tablet PC, a laptop PC, a tablet terminal, a cellular phone, or a PDA. In response to an operation performed by the user, the terminal device 100 obtains a webpage from the contents server device 20 and displays the obtained webpage. Moreover, when the webpage includes an advertisement acquisition instruction, the terminal device 100 obtains an advertising content from the advertisement server device 200 and displays the obtained advertising content along with the webpage. Furthermore, according to the control information, the terminal device 100 performs display control with respect to the advertising content and obtains information related to the user browsing of the displayed advertising content.

The advertisement server device 200 is a server device for delivering the advertising content that has been submitted from the advertiser terminal 5. For example, when an advertisement request for delivering the advertising content is received from the terminal device 100, the advertisement server device 200 delivers the advertising content to the terminal device 100. Moreover, the advertisement server device 200 delivers, to the terminal device 100, control information that is meant to make the terminal device 100 to obtain information related to the browsing behavior of the user and information related to the user operations. The control information is written in, for example, a script language such as JavaScript (registered trademark) or cascading style sheets (CSS). Then, based on the information related to the browsing behavior of the user and the information related to the user operations, the advertisement server device 200 performs an operation for calculating the charge amount to be charged to the advertiser.

### 3. CONFIGURATION OF TERMINAL DEVICE

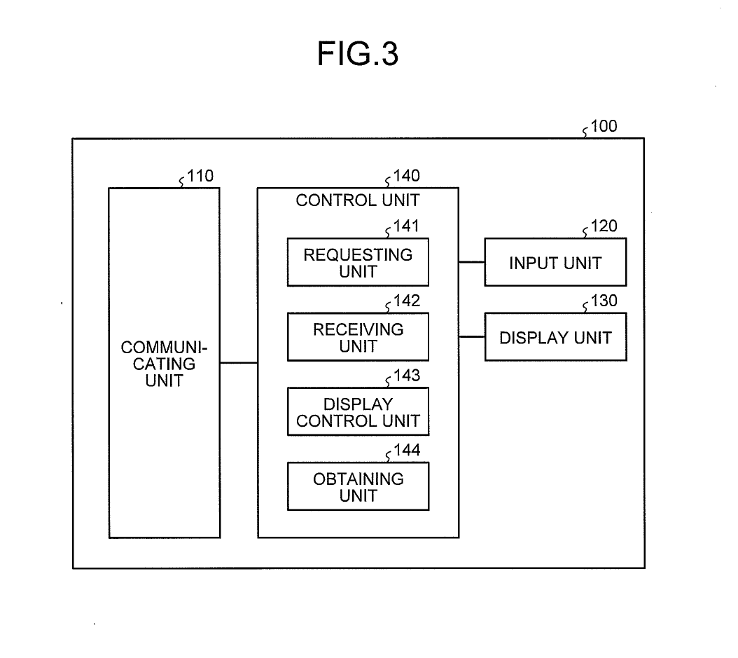

Explained below with reference to FIG. 3 is a configuration of the terminal device 100 according to the embodiment. FIG. 3 is a diagram illustrating an exemplary configuration of the terminal device 100 according to the embodiment. As illustrated in FIG. 3, the terminal device 100 includes a communicating unit 110, an input unit 120, the display unit 130, and a control unit 140.

The communicating unit 110 is implemented using a network interface card (NIC), for example. Moreover, the communicating unit 110 is connected to the network N in a wired or wireless manner, and performs communication of information with the contents server device 20 and the advertisement server device 200.

The input unit 120 is an input device for receiving various operations from the user. For example, the input unit 120 is implemented using a keyboard, a mouse, or operation keys. The display unit 130 is a display device for displaying a variety of information. For example, the display unit 130 is implemented using a liquid crystal display. Meanwhile, if a touch-sensitive panel is used in the terminal device 100, then the input unit 120 and the display unit 130 are integrated.

The control unit 140 is implemented when a central processing unit (CPU) or a micro processing unit (MPU) executes various computer programs, which are stored in a memory device in the terminal device 100, while using a random access memory (RAM) as the work area. For example, the various computer programs correspond to an application program called a web browser. Meanwhile, the control unit 140 can alternatively be implemented using an integrated circuit such as an application specific integrated circuit (ASIC) or a field programmable gate array (FPGA).

As illustrated in FIG. 3, the control unit 140 includes a requesting unit 141, a receiving unit 142, a display control unit 143, and an obtaining unit 144. The control unit 140 implements or executes the functions or the mechanism of the information processing described below. Meanwhile, the internal configuration of the control unit 140 is not limited to the configuration illustrated in FIG. 3, and any other configuration can be used as long as the information processing described later can be performed. Moreover, the relation of connection among the processing units of the control unit 140 is not limited to the relation of connection illustrated in FIG. 3, and any other relation of connection can be maintained. Furthermore, in the control unit 140; the receiving unit 142, the display control unit 143, and the obtaining unit 144 are generated when the control information is run.

In response to a user operation performed using the input unit 120, the requesting unit 141 sends a page request to the contents server device 20 as a request for delivering a webpage. Moreover, when an advertisement acquisition instruction is included in the webpage received by the receiving unit 142, the requesting unit 141 sends an advertisement request to the advertisement server device 200 as a request for delivering advertising contents.

The receiving unit 142 receives webpages and advertising contents. More particularly, from the contents server device 20 that responded to the request issued by the requesting unit 141 for delivering a webpage, the receiving unit 142 receives a webpage that includes an advertising space representing an advertisement display area. At that time, if an advertisement acquisition instruction is included in the webpage, the receiving unit 142 instructs the requesting unit 141 to issue an advertisement request for delivering advertising content. Then, the receiving unit 142 receives the advertising content from the advertisement server device 200 that responded to the advertisement request issued by the requesting unit 141.

The display control unit 143 performs display control to display, on the display unit 130, the advertising content received by the receiving unit 142. Meanwhile, in the present embodiment, although the explanation is given for a case in which the display control unit 143 performs display control related particularly to an advertising content, the display control unit 143 can perform display control also to display the webpage received by the receiving unit 142 on the display unit 130.

Given below is the explanation about advertising contents according to the present embodiment. In the present embodiment, an advertising content is displayed to be bigger than the size of the display unit 130. For example, an advertising space bigger than the size of the display unit 130 is provided on the webpage, so that the advertising content put in that advertising space gets displayed to be bigger than the size of the display unit 130.

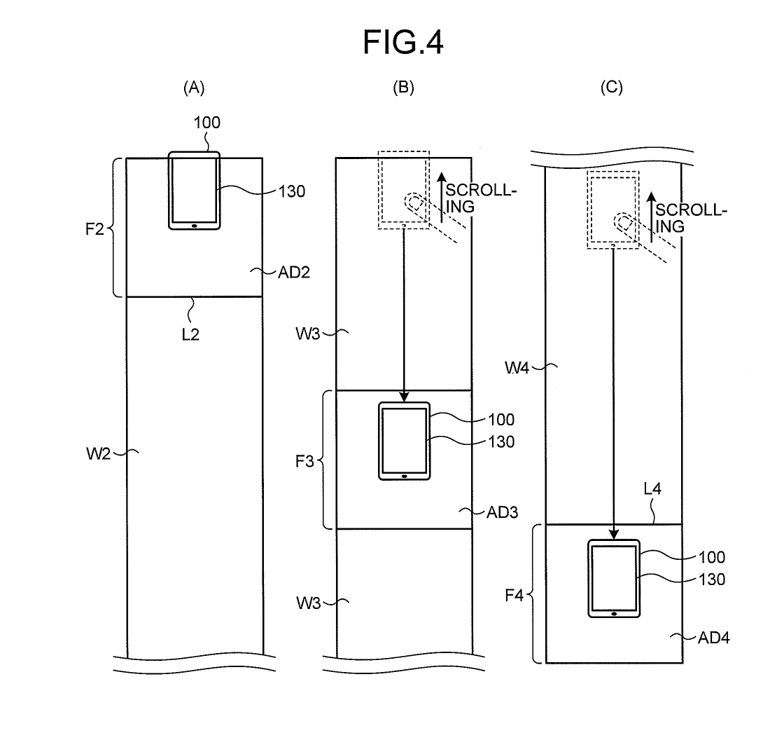

In FIG. 1 is illustrated an example in which the advertising content is vertically longer than the vertical size of the display unit 130 but has the same horizontal size as the horizontal size of the display unit 130. Moreover, in FIG. 1 is illustrated an example in which the advertising space is positioned at the upper end of the webpage. However, those are not the only possible cases. That point is explained with reference to FIG. 4. Herein, FIG. 4 is a diagram for explaining about the aspect of the size of the advertising content with respect to the display unit 130 and about the position of placement of the advertising space in the webpage.

For example, in (A) in FIG. 4 is illustrated an example in which some part of an advertising content AD2 put in an advertising space F2 gets displayed on the display unit 130. As illustrated in this example, an advertising content can be vertically longer than the vertical size of the display unit 130 and can be horizontally longer than the horizontal size of the display unit 130. In (B) and (C) in FIG. 4 too, the same holds true.

The following explanation is about the position of placement of an advertising space in a webpage. As illustrated in (A) in FIG. 4, an advertising space can be positioned at an upper end L2 of the webpage. In (A) in FIG. 4 is illustrated an example in which the advertising space F2 is positioned at the upper end L2 of the webpage. For example, in the terminal device 100, in response to a request issued by the requesting unit 141 to the contents server device 20 for a webpage W2, the receiving unit 142 receives the webpage W2. Moreover, since the advertising space F2, in which an advertising content bigger than the size of the display unit 130 is put, is placed at the upper end L2 of the received webpage W2; the receiving unit 142 receives the advertising content AD2 in response to an advertisement request issued by the requesting unit 141 to the advertisement server device 200. Then, according to the position relationship indicating that the advertising space F2 is positioned at the upper end L2 of the webpage W2, the display control unit 143 puts the advertising content AD2 in the advertising space F2 and performs the initial display of the advertising content AD2 on the display unit 130.

Given below is the explanation about (B) in FIG. 4. As illustrated in (B) in FIG. 4, the advertising space can be inserted inside the webpage. In (B) in FIG. 4 is illustrated an example in which an advertising space F3 is inserted inside a webpage W3. For example, in the terminal device 100, in response to a request issued by the requesting unit 141 to the contents server device 20 for the webpage W3, the receiving unit 142 receives the webpage W3. Moreover, since the advertising space F3, in which advertising content bigger than the size of the display unit 130 is put, is inserted inside the received webpage W3; the receiving unit 142 receives an advertising content AD3 in response to an advertisement request issued by the requesting unit 141 to the advertisement server device 200. Then, according to the position relationship indicating that the advertising space F3 is inside the webpage W3, the display control unit 143 puts the advertising content AD3 in the advertising space F3 and performs the initial display of the advertising content AD3 on the display unit 130. In such a case, the display control unit 143 displays the advertising content AD3 according to, for example, the scrolling performed by the user.

Given below is the explanation about (C) in FIG. 4. As illustrated in (C) in FIG. 4, the advertising space can be positioned at the lower end of the webpage. In (C) in FIG. 4 is illustrated an example in which an advertising space F4 is positioned at a lower end L4 of the webpage. For example, in the terminal device 100, in response to a request issued by the requesting unit 141 to the contents server device 20 for a webpage W4, the receiving unit 142 receives the webpage W4. Moreover, since the advertising space F4, in which an advertising content bigger than the size of the display unit 130 is put, is positioned at the lower end of the received webpage W4; the receiving unit 142 receives an advertising content AD4 in response to an advertisement request issued by the requesting unit 141 to the advertisement server device 200. Then, according to the position relationship indicating that the advertising space F4 is positioned at the lower end L4 of the webpage W4, the display control unit 143 puts the advertising content AD4 in the advertising space F4 and performs the initial display of the advertising content AD4 on the display unit 130. In such a case, the display control unit 143 displays the advertising content AD4 according to, for example, the scrolling performed by the user.

Returning to the explanation with reference to FIG. 3, the obtaining unit 144 obtains the browsing behavior of the user with respect to an advertising content. More particularly, as information related to the browsing behavior, the obtaining unit 144 obtains the display rate, the visual confirmation rate, and the display period of the advertising content; as well as obtains the operation period, the movement amount, and the movement speed of the advertising content that is operated by the user. Given below is the explanation of each type of information.

For example, the obtaining unit 144 obtains the display rate which represents the ratio of the dimension of the portions of an advertising content displayed on the display unit 130 with respect to the dimension of the entire advertising content.

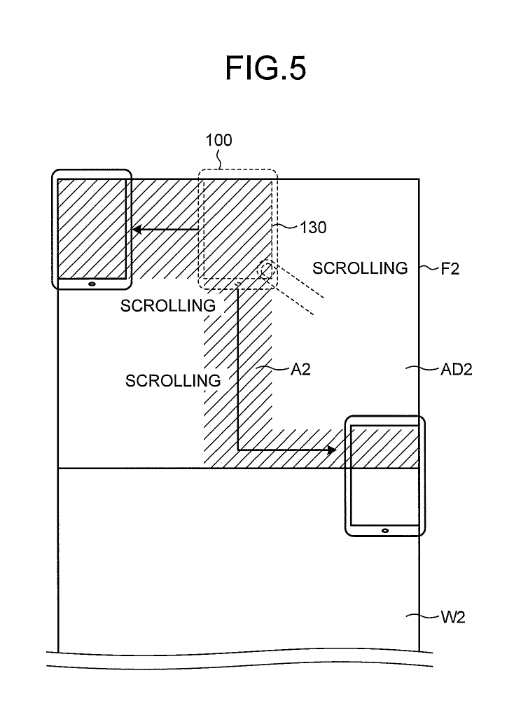

Explained below with reference to FIG. 5 is an example of a display rate obtaining operation performed by the obtaining unit 144. FIG. 5 is a diagram illustrating an example of the display rate obtaining operation. Herein, it is assumed that the positional relationship between an advertising content and a webpage as illustrated in FIG. 5 corresponds to (A) in FIG. 4. Firstly, the obtaining unit 144 determines whether or not an advertising content is displayed on the display unit 130. In FIG. 5, since the display control unit 143 has performed the initial display of the advertising content AD2 on the display unit 130, the obtaining unit 144 determines that the advertising content AD2 is displayed on the display unit 130.

As a result of determining that the advertising content AD2 is displayed on the display unit 130, the obtaining unit 144 continuously stores the dimension of the display unit 130 on which the advertising content AD2 is displayed. Herein, a hatched area A2 illustrated in FIG. 5 represents the area in which the advertising content AD2 is displayed on the display unit 130 because of scrolling. Subsequently, when the advertising content AD2 is no longer displayed on the display unit 130 because of scrolling, or because of moving on to another webpage, or because of switching OFF the power of the terminal device 100; the obtaining unit 144 calculates the dimension of the hatched area A2 that is stored. Then, the obtaining unit 144 obtains the display rate as the ratio of the dimension of the hatched area A2 with respect to the dimension of the entire advertising content AD2; associates the advertisement ID enabling identification of the advertising content AD2 and a user ID enabling identification of the terminal device 100 with the obtained display rate; and sends that information to the advertisement server device 200.

Meanwhile, it is desirable to perform the setting of the obtaining unit 144 in such a way that the hatched area once stored for each user ID is not redundantly stored.

Meanwhile, as the information related to the browsing behavior, the obtaining unit 144 obtains the visual confirmation rate representing the dimension of the area in which the user has visually confirmed an advertising content as against the dimension of the entire advertising content. In that case, the premise is that a predetermined web camera is installed in the terminal device 100.

Given below is the explanation of an example of a visual confirmation rate obtaining operation performed by the obtaining unit 144. For example, the obtaining unit 144 determines whether or not an advertising content is displayed on the display unit 130. If it is determined that an advertising content is displayed on the display unit 130, then the obtaining unit 144 obtains a visual confirmation area for the user in the advertising content as detected by the web camera using the eye tracking technology. Then, the obtaining unit 144 calculates the dimension of the visual confirmation area. Subsequently, the obtaining unit 144 obtains the visual confirmation rate representing the ratio of the dimension of the visual confirmation area with respect to the dimension of the entire advertising content; associates the advertisement ID enabling identification of the advertising content and the user ID enabling identification of the terminal device 100 with the obtained visual confirmation rate; and sends that information to the advertisement server device 200.

Meanwhile, it is desirable to perform the setting of the obtaining unit 144 in such a way that the visual confirmation area once stored for each user ID is not redundantly obtained. Moreover, if a plurality of visual confirmation areas is present in a single advertising content, then the obtaining unit 144 uses the total of the dimensions of the visual confirmation areas in obtaining the visual confirmation rate.

Meanwhile, as information related to the browsing behavior, the obtaining unit 144 obtains the display period representing the period of time for which the advertising content is displayed on the display unit 130. Given below is the explanation of an example of a display period obtaining operation performed by the obtaining unit 144. For example, the obtaining unit 144 determines the display state indicating whether or not an advertising content is displayed on the display unit 130. For example, depending on whether or not a predetermined percentage of the dimension of the entire advertising content is within the display unit 130, the obtaining unit 144 determines the display state of the advertising content on the display unit 130.

If it is determined that the advertising content is displayed on the display unit 130, then the obtaining unit 144 starts measuring the display period. On the other hand, when it is determined that the advertising content is not displayed on the display unit 130, the obtaining unit 144 obtains the display period by stopping the display period measurement. Then, the obtaining unit 144 associates the advertisement ID enabling identification of the concerned advertising content and the user ID enabling identification of the terminal device 100 with the obtained display period; and sends that information to the advertisement server device 200.

Till now, the explanation is given about the operations by which the obtaining unit 144 obtains the information related to the browsing behavior of the user with respect to an advertising content. Alternatively, the obtaining unit 144 can obtain information related to the user operations with respect to an advertising content. Given below is the explanation about the operations by which the obtaining unit 144 obtains information related to the user operations with respect to an advertising content.

As the information related to the user operations, the obtaining unit 144 obtains the operation period representing the period of time for which the user performs operations with respect to an advertising content that is displayed on the display unit 130. More particularly, when an advertising content is displayed on the display unit 130, the operation period indicates the period of time for which the user is touching the display unit 130 to perform touch interactions, scrolling, or pinching with respect to the display unit 130.

Given below is the explanation of an example of an operation period obtaining operation performed by the obtaining unit 144. Firstly, the obtaining unit 144 determines the display state indicating whether or not an advertising content is displayed on the display unit 130. For example, depending on whether or not a predetermined percentage of the dimension of the entire advertising content is included in the display unit 130, the obtaining unit 144 determines the display state of the advertising content on the display unit 130.

If it is determined that the advertising content is displayed on the display unit 130, then the obtaining unit 144 measures the period of time for which the user is touching the display unit 130 to perform operations. For example, if it is determined that the advertising content is displayed on the display unit 130, then the obtaining unit 144 starts the measurement upon detecting a user operation with respect to the display unit 130, and obtains the operation period by stopping the measurement when the user operation can no more be detected. Then, the obtaining unit 144 associates the advertisement ID enabling identification of the concerned advertising content and the user ID enabling identification of the terminal device 100 with the obtained operation period; and sends that information to the advertisement server device 200.

Meanwhile, as the information related to the user operation, the obtaining unit 144 obtains the movement amount for which an advertising content displayed on the display unit 130 is scrolled. More particularly, the movement amount represents the amount for which the advertising content is moved within the display unit 130 according to the movement of a finger of the user on the display unit 130.

Explained with reference to FIG. 1 is an example of a movement amount obtaining operation performed by the obtaining unit 144. Firstly, the obtaining unit 144 determines the display state indicating whether or not an advertising content is displayed on the display unit 130. For example, depending on whether or not a predetermined percentage of the dimension of the entire advertising content is included in the display unit 130, the obtaining unit 144 determines the display state of the advertising content on the display unit 130.

In the first state illustrated in FIG. 1, since the display control unit 143 has performed the initial display of the advertising content AD1 on the display unit 130, the obtaining unit 144 determines that the advertising content AD1 is displayed on the display unit 130. When the advertising content AD1 is displayed on the display unit 130, the obtaining unit 144 detects scrolling of the advertising content AD1 and obtains the movement amount during the detection.

For example, as illustrated in FIG. 1, when the display state of the advertising content AD1 in the display unit 130 is the first state, if the user performs upward scrolling with respect to the display unit 130, the obtaining unit 144 starts the detection of scrolling of the advertising content AD1 within the display unit 130 according to the upward scrolling performed by the user, and goes on obtaining the movement amount of the advertising content AD1 during the detection. When the user ends the scrolling and when the display state of the advertising content AD1 in the display unit 130 changes to the second state, the obtaining unit 144 ends the detection of scrolling and calculates the movement amount of the advertising content AD1 within the display unit 130 during the period of time when the display state changed from the first state to the second state due to scrolling.

Then, the obtaining unit 144 associates the advertisement ID enabling identification of the concerned advertising content and the user ID enabling identification of the terminal device 100 with the movement amount obtained as a result of the operation described above; and sends that information to the advertisement server device 200.

Meanwhile, as the information related to the user operations, in addition to obtaining the movement amount, the obtaining unit 144 can also obtain the movement direction that indicates the direction in which the advertising content displayed on the display unit 130 is moved due to scrolling. With reference to FIG. 1, upon starting the detection of scrolling of the advertising content AD1 within the display unit 130, the obtaining unit 144 continuously goes on obtaining the movement locus of the advertising content AD1 along with obtaining the movement amount. When the detection of scrolling is ended, it also marks the end of obtaining the movement locus of the advertising content AD1. Then, the obtaining unit 144 determines the movement direction based on the obtained movement locus. For example, the obtaining unit 144 treats the obtained movement locus as a straight line, and determines the movement direction according to the angle of inclination of the movement locus. For example, within the range of 0° to 45° of the inclination of the movement locus, the obtaining unit 144 determines that the movement direction is horizontal. On the other hand, within the range of 46° to 90° of the inclination of the movement locus, the obtaining unit 144 determines that the movement direction is vertical.

In FIG. 1 is illustrated an example in which the advertising content AD1 moves upward within the display unit 130 in response to upward scrolling performed by the user. Hence, for example, the obtaining unit 144 determines that the movement direction of the advertising content AD1 is vertical. Meanwhile, also when the advertising content moves downward according to downward scrolling, the obtaining unit 144 can determine that the movement direction is vertical.

Then, the obtaining unit 144 associates the advertisement ID enabling identification of the concerned advertising content and the user ID enabling identification of the terminal device 100 with the movement amount and the movement direction; and sends that information to the advertisement server device 200.

In the example illustrated in FIG. 1, the horizontal size of the advertising content AD1 matches with the horizontal size of the display unit 130. In that case, for example, the user cannot scroll the advertising content AD1 in the horizontal direction or in an oblique direction. In contrast, as illustrated in FIG. 4, when the horizontal size of the advertising content is greater than the horizontal size of the display unit 130, the user may scroll in the horizontal direction or an oblique direction. When the advertising content moves to the left or to the right, the obtaining unit 144 determines that the movement direction is horizontal.

Moreover, as the information related to the user operations, the obtaining unit 144 obtains the movement speed of the advertising content that is displayed on the display unit 130. As described earlier, the obtaining unit 144 obtains the operation period, which represents the period of time for which the user performs operations with respect to the advertising content displayed on the display unit 130, and the movement amount of the advertising content displayed on the display unit 130. Thus, for example, using the operation period and the movement amount, the obtaining unit 144 obtains the movement amount per unit of the operation period as the movement speed. Then, the obtaining unit 144 associates the advertisement ID enabling identification of the concerned advertising content and the user ID enabling identification of the terminal device 100 with the movement speed; and sends that information to the advertisement server device 200.

### 4. ADVERTISEMENT SERVER DEVICE

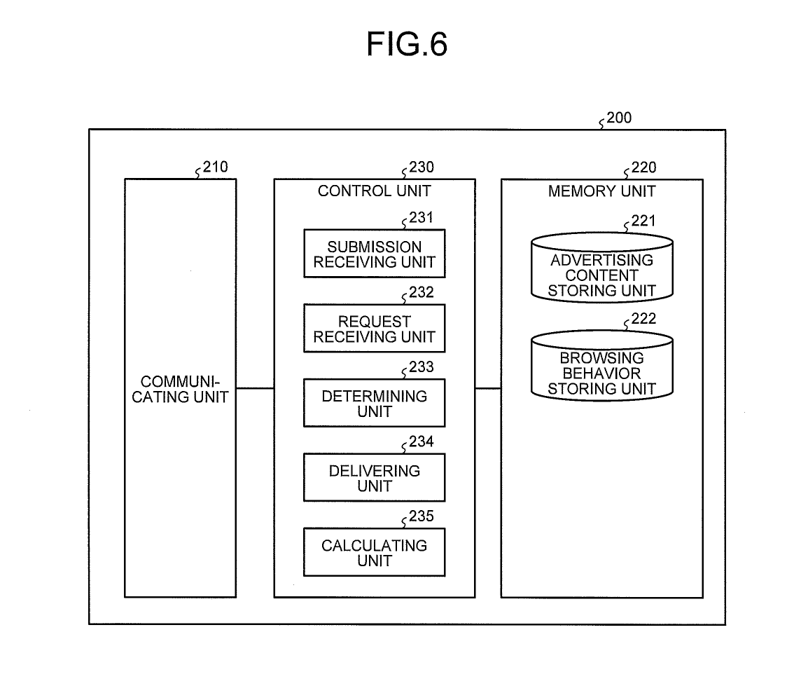

Given below is the explanation of a configuration of the advertisement server device 200 according to the embodiment. FIG. 6 is a diagram illustrating an exemplary configuration of the advertisement server device 200 according to the embodiment. As illustrated in FIG. 6, the advertisement server device 200 includes a communicating unit 210, a memory unit 220, and a control unit 230.

The communicating unit 210 is implemented using a network interface card (NIC), for example. Moreover, the communicating unit 210 is connected to the network N in a wired or wireless manner, and performs communication of information with the advertiser terminal 5, the contents server device 20, and the terminal device 100.

The memory unit 220 is implemented using a semiconductor memory element such as a random access memory (RAM) or a flash memory, or using a memory device such as a hard disk or an optical disk. The memory unit 220 includes an advertising content storing unit 221 and a browsing behavior storing unit 222.

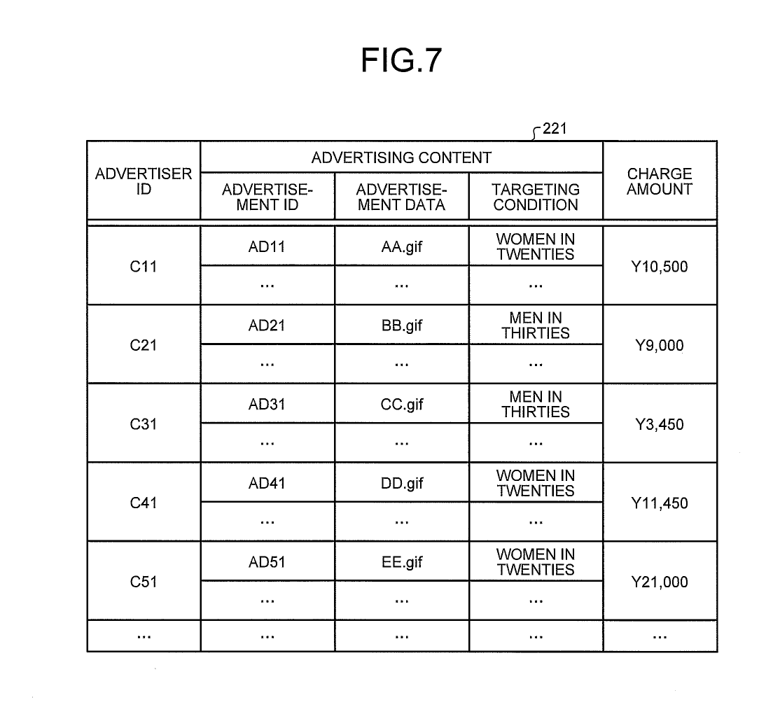

The advertising content storing unit 221 is used to store a variety of information related to the advertising contents submitted from the advertiser terminal 5. In FIG. 7 is illustrated an example of the advertising content storing unit 221 according to the embodiment. In the example illustrated in FIG. 7, the advertising content storing unit 221 includes the following items: “advertiser ID”, “advertisement ID”, “advertisement data”, “targeting condition”, and “charge amount”.

The “advertiser ID” represents identification information enabling identification of the advertiser or the advertiser terminal 5. The “advertisement ID” represents identification information enabling identification of an advertising content submitted from the advertiser terminal 5. The “advertisement data” represents data of the advertising content that is put in an advertising space. The advertising content is displayed to be bigger than the display size of the display unit 130 of the terminal device 100. In practice, the “advertisement data” represents a still image, a moving image, text data, a URL, or a file path indicating the storage location of the data. In the present embodiment, each advertising content is written in a distinguishable manner using the “advertisement ID” such as the advertising content AD1.

The “targeting condition” represents information for specifying the users for whom the advertising content is to be delivered; and is set by the advertiser, for example. A determining unit 233 (described later) refers to the targeting condition and determines the advertising content to be delivered to the users. The “charge amount” is calculated by a calculating unit 235 (described later), and represents the amount to be charged to an advertiser.

Thus, in FIG. 7 is illustrated an example in which the advertiser identified by an advertiser ID “C11” submits advertisement data “AA.gif” identified by an advertisement ID “AD11” and specifies a targeting condition “women in twenties” for the advertisement data “AA.gif”. Moreover, it is illustrated that the advertiser identified by the advertisement ID “C11” is asked to pay a charge amount of “Y10,500” by the advertisement server device 200.

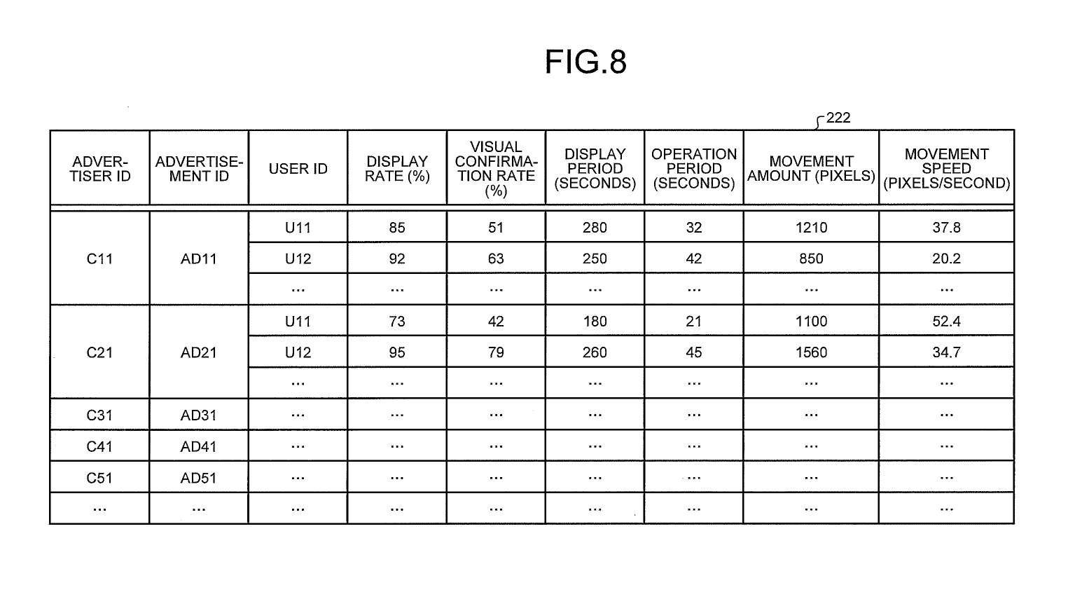

The browsing behavior storing unit 222 is used to store information related to the browsing behavior of users and information related to the user operations with respect to the advertising contents displayed to be bigger than the size of the display unit 130. In FIG. 8 is illustrated an example of the browsing behavior storing unit 222 according to the embodiment. In the example illustrated in FIG. 8, the browsing behavior storing unit 222 includes the following items: “advertiser ID”, “advertisement ID”, “user ID”, “display rate”, “visual confirmation rate”, “display period”, “operation period”, “movement amount”, and “movement speed”.

The “advertiser ID” and the “advertisement ID” are identical to the “advertiser ID” and the “advertisement ID”, respectively, stored in the advertising content storing unit 221. Hence, the explanation is not repeated. The user ID represents identification information enabling identification of the terminal device 100 or identification of the user of the terminal device 100.

The “display rate” represents the ratio of the dimension of the advertising content, which is displayed on the display unit 130, with respect to the dimension of the entire advertising content. The “visual confirmation rate” represents the dimension of the area in which the user has visually confirmed the advertising content as against the dimension of the entire advertising content. The “display period” represents the period of time for which the advertising content is displayed on the display unit 130.

The “operation period” represents the period of time for which the user performs operations with respect to the advertising content that is displayed on the display unit 130. The “movement amount” represents the amount of movement of the advertising content, which is displayed on the display unit 130, due to scrolling. The “movement speed” represents the speed of movement of the advertising content, which is displayed on the display unit 130, as a result of scrolling. Thus, the variety of information stored in the browsing behavior storing unit 222 is obtained by the obtaining unit 144 of the terminal device 100.

Thus, in FIG. 8 is illustrated an example in which, the advertising content identified by the advertisement ID “AD11” and submitted from an advertiser identified by the advertiser ID “C11” has the display rate of “85%”, the visual confirmation rate “51%”, the display period of “280 seconds”, the operation period of “32 seconds”, the movement amount “1210 pixels”, and the movement speed of “37.8 pixels/second” with the user identified by a user ID “U11”.

Returning to the explanation with reference to FIG. 6, the control unit 230 is implemented, for example, when a CPU or an MPU executes various computer programs, which are stored in a memory device in the advertisement server device 200, while using a RAM as the work area. Meanwhile, the control unit 230 can alternatively be implemented using an integrated circuit such as an ASIC or an FPGA.

As illustrated in FIG. 6, the control unit 230 includes a submission receiving unit 231, a request receiving unit 232, the determining unit 233, a delivering unit 234, and the calculating unit 235. Moreover, the control unit 230 implements or executes the functions or the mechanism of the information processing described below. Meanwhile, the internal configuration of the control unit 230 is not limited to the configuration illustrated in FIG. 6, and any other configuration can be used as long as the information processing described later can be performed. Moreover, the relation of connection among the processing units of the control unit 230 is not limited to the relation of connection illustrated in FIG. 6, and any other relation of connection can be maintained.

The submission receiving unit 231 receives submission of an advertising content from the advertiser terminal 5. More particularly, along with receiving the advertising content that is to be put in the advertising space, the submission receiving unit 231 receives specification of the target condition. Then, in the advertising content storing unit 221; the submission receiving unit 231 stores the advertisement ID, the advertisement data, and the targeting condition in a corresponding manner to the advertiser ID of the submitting advertiser. For example, in the example illustrated in FIG. 7, the submission receiving unit 231 receives specification of the targeting condition “women in twenties” and receives the data “AA.gif” of the advertising content from the advertiser terminal 5.

The request receiving unit 232 receives, from the terminal device 100, an advertisement request for delivering an advertising content. For example, the request receiving unit 232 receives an advertisement request in the form of an HTTP request.

When an advertisement request is received by the request receiving unit 232, the determining unit 233 determines the advertising content to be delivered to the terminal device 100. For example, the advertisement server device 200 stores the user ID and the user attributes (age, gender, and address) in a memory unit (not illustrated). Then, from the memory unit, the determining unit 233 obtains the user attributes corresponding to the user ID of the terminal device 100 that issued the advertisement request. Subsequently, the determining unit 233 accesses the advertising content storing unit 221, matches the obtained user attributes and the targeting condition, and determines the advertising content corresponding to the targeting condition which matches with the user attributes as the advertising content to be delivered.

In the example of the advertising content storing unit 221 illustrated in FIG. 7, the same targeting condition repeats for a plurality of number of times. In that case, based on the matching of the user attributes and the targeting condition, based on the bid price (not illustrated) that is specified to the advertiser at the time of submission of the advertising content, and based on the certified test result (CTR) according to the delivery records of each advertising content; the determining unit 233 narrows down to a single advertising content to be delivered or a predetermined number of advertising contents to be delivered. For example, the determining unit 233 preferentially determines the advertising content having a high bid price or a high CTR or preferentially determines the advertising content having a high bid price and a high CTR as the target for delivery. Then, the determining unit 233 outputs the determined advertising content to the delivering unit 234.

The delivering unit 234 delivers the advertising content determined by the determining unit 233, as well as delivers control information that is used in making the terminal device 100 to perform display control and to obtain information related to the browsing behavior of the user and information related to the user operations with respect to the advertising content displayed on the display unit 130. More particularly, upon receiving the advertising content determined by the determining unit 233, the delivering unit 234 generates the control information. Then, the delivering unit 234 delivers the advertising content and the control information to the terminal device 100 that issued the advertisement request.

Moreover, the delivering unit 234 receives information related to the browsing behavior of the user and information related to the user operations with respect to the advertising content displayed on the display unit 130. Herein, each type of information is obtained and sent by the obtaining unit 144. More particularly, every time such information is received in a corresponding manner to an advertiser ID and an advertisement ID, the delivering unit 234 adds the value representing each type of information received in a corresponding manner to the advertiser ID and the advertisement ID as illustrated in the browsing behavior storing unit 222 illustrated in FIG. 8, and stores the result in the browsing behavior storing unit 222.

The calculating unit 235 calculates the charge amount that is to be charged to the advertiser as the advertisement delivery charge. More particularly, the calculating unit 235 accesses the browsing behavior storing unit 222 and calculates the charge amount based on the “display rate”, the “visual confirmation rate”, the “display period”, the “operation period”, the “movement amount”, and the “movement speed” that represent the information related to the browsing behavior of the user and the information related to the user operations with respect to the advertising content displayed on the display unit 130.

For example, greater the values of the “display rate”, the “visual confirmation rate”, the “display period”, the “operation period”, and the “movement amount”; it can be expected that the user had a high interest in the advertising content and was paying more attention to the advertising content. For that reason, regarding the “display rate”, the “visual confirmation rate”, the “display period”, the “operation period”, and the “movement amount”; greater the value of each item, greater is the charge amount calculated by the calculating unit 235.

On the other hand, smaller the value of the “movement speed”, it can be expected that the user was paying more attention to the advertising content. Hence, smaller the value of the “movement speed”, greater is the charge amount calculated by the calculating unit 235.

Then, for example, for each advertisement ID, the calculating unit 235 calculates a subtotal amount of the charge amount calculated for each of the “display rate”, the “visual confirmation rate”, the “display period”, the “operation period”, the “movement amount”, and the “movement speed” for each user ID. Subsequently, for each advertisement ID, the calculating unit 235 adds the subtotal amounts calculated for each user ID and calculates a total amount. Then, based on the advertiser ID corresponding to the concerned advertisement ID, the calculating unit 235 stores the calculated total amount as the charge amount in the advertising content storing unit 221 illustrated in FIG. 7. Herein, the calculating unit 235 performs this calculation operation after every predetermined period of time (for example, one month).

Meanwhile, as described earlier, when the obtaining unit 144 of the terminal device 100 obtains the movement amount as well as the movement direction, the calculating unit 235 can calculate the charge amount also by taking into account the movement direction. For example, when the movement direction is vertical, the calculating unit 235 calculates a high charge amount. However, when the movement direction is horizontal, the calculating unit 235 calculates a low charge amount. Thus, the charge amount can be varied according to the movement direction.

Generally, while browsing a webpage or an advertising content, although dependent on the shape of the webpage or the advertising content, it is believed that the user often performs browsing by scrolling in the vertical direction than in the horizontal direction. Hence, as described above, when the movement direction is vertical, the calculating unit 235 can increase the amount to be charged as compared to the horizontal movement direction.

### 5. FLOW OF ADVERTISEMENT OPERATION

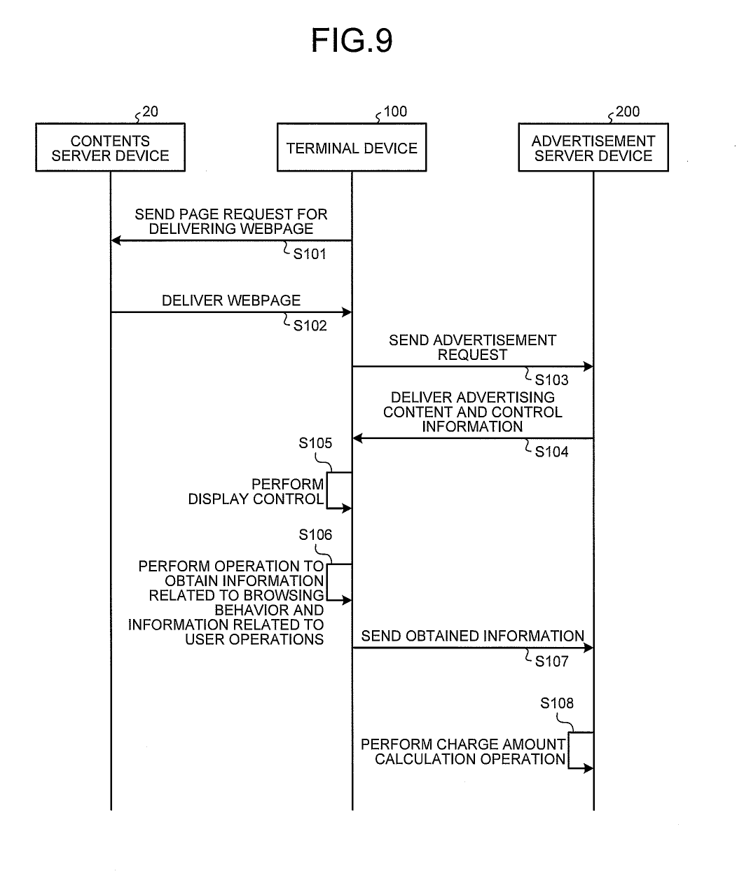

Explained below with reference to FIG. 9 is a sequence of operations during an advertisement operation performed in the advertisement system 1 according to the embodiment. FIG. 9 is a sequence diagram illustrating a sequence of operations during an advertisement operation performed in the advertisement system 1 according to the embodiment.

As illustrated in FIG. 9, according to a user operation, the terminal device 100 sends a page request for delivering a webpage to the contents server device 20 (Step S101). In response to the page request for delivering a webpage, the contents server device 20 delivers a webpage to the terminal device 100 (Step S102). The webpage delivered by the contents server device 20 includes an advertisement acquisition instruction in the form of the URL of the advertisement server device 200.

Then, based on the advertisement acquisition instruction included in the webpage, the terminal device 100 sends an advertisement request for delivering an advertising content to the advertisement server device 200 (Step S103). In response to the advertisement request, the advertisement server device 200 delivers an advertising content and control information to the terminal device 100 (Step S104). Herein, the display size of the advertising content on the display unit 130 of the terminal device 100 is bigger than the size of the display unit 130.

Then, according to the control information received along with the advertising content at Step S104, the terminal device 100 performs display control to display the webpage received at Step S102 and the advertising content (Step S105). For example, the terminal device 100 puts the received advertising content in the advertising space of the received webpage. Then, for example, as illustrated in (A) in FIG. 4, when the advertising space is set at the top of the webpage, the terminal device 100 displays the received advertising content in the first place on the display unit 130 (performs the initial display).

Subsequently, according to the control information, the terminal device 100 performs an operation to obtain information related to the browsing behavior of the user and information related to the user operations with respect to the advertising content displayed on the display unit 130 (Step S106). More particularly, as the information related to the browsing behavior of the user, the terminal device 100 obtains the “display rate” of the advertising content on the display unit 130, obtains the “visual confirmation rate” of the user with respect to the advertising content displayed on the display unit 130, and obtains the “display period” of the advertising content on the display unit 130. Moreover, as the information related to the user operations, the terminal device 100 obtains the “operation period” of the user with respect to the advertising content displayed on the display unit 130 and obtains the “movement amount” and the “movement speed” of the advertising content on the display unit 130. Every time the variety of information mentioned above is obtained, the terminal device 100 sends that information to the advertisement server device 200 (Step S107).

Based on the information received at Step S107, the advertisement server device 200 performs a calculation operation to calculate the charge amount to be charged to each advertiser (Step S108). Moreover, although not illustrated in FIG. 9, the advertisement server device 200 sends the calculated charge amount to each advertiser terminal 5 and notifies the advertisers about the charge amounts.

### 6. MODIFICATION EXAMPLES

The advertisement system 1 according to the embodiment described above can be implemented in various other illustrative embodiments other than the embodiment described above. Given below is the explanation of other illustrative embodiments of the advertisement system 1. The terminal device 100 explained below performs display control with respect to an advertising content according to control information included in the advertising content.

6-1. Relevant Content (1)

In addition to receiving an advertising content having the display size bigger than the size of the display unit 130 from an advertisement server device, the terminal device 100 described above can also receive a content having the display size smaller than the size of the display unit 130 and being relevant to the advertising content (in the following explanation, sometimes written as a “relevant content”). Then, according to the instructions specified in the control information, the display control unit 143 of the terminal device 100 controls the display format of the advertising content and the relevant content that are received. As described later, the display control unit 143 displays the relevant content in an overlapping manner on the advertising content.

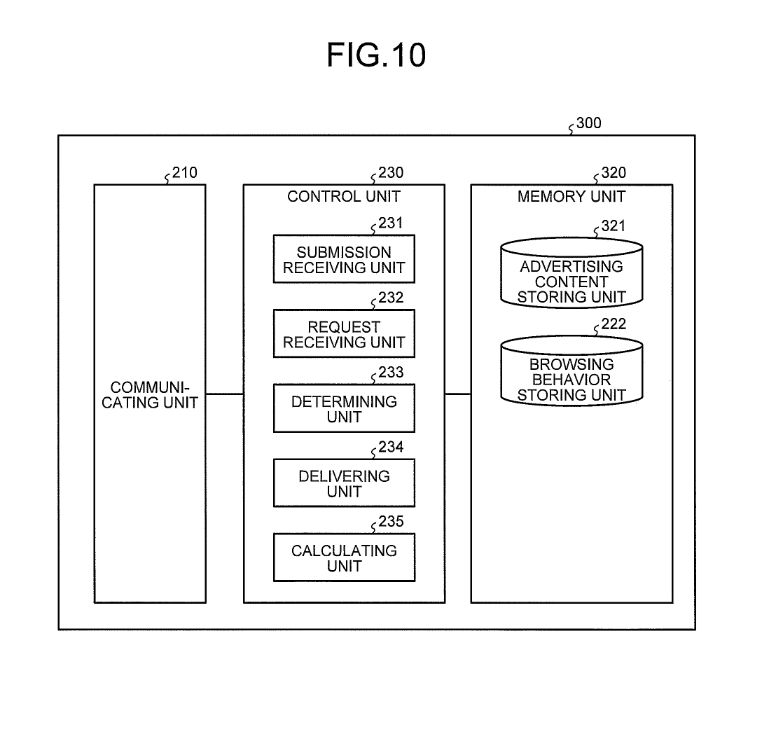

Meanwhile, it is assumed that the relevant content is submitted along with the advertising content by an advertiser to an advertisement server device 300. Firstly, given below is the explanation of a configuration of the advertisement server device 300 according to a modification example. FIG. 10 is a diagram illustrating an exemplary configuration of the advertisement server device 300 according to the modification example. The advertisement server device 300 includes an advertising content storing unit 321 that is used to store different information than the information stored in the advertising content storing unit 221 illustrated in FIGS. 6 and 7. Aside from that, the advertisement server device 300 includes the same constituent elements as those in the advertisement server device 200. Hence, that explanation is not repeated.

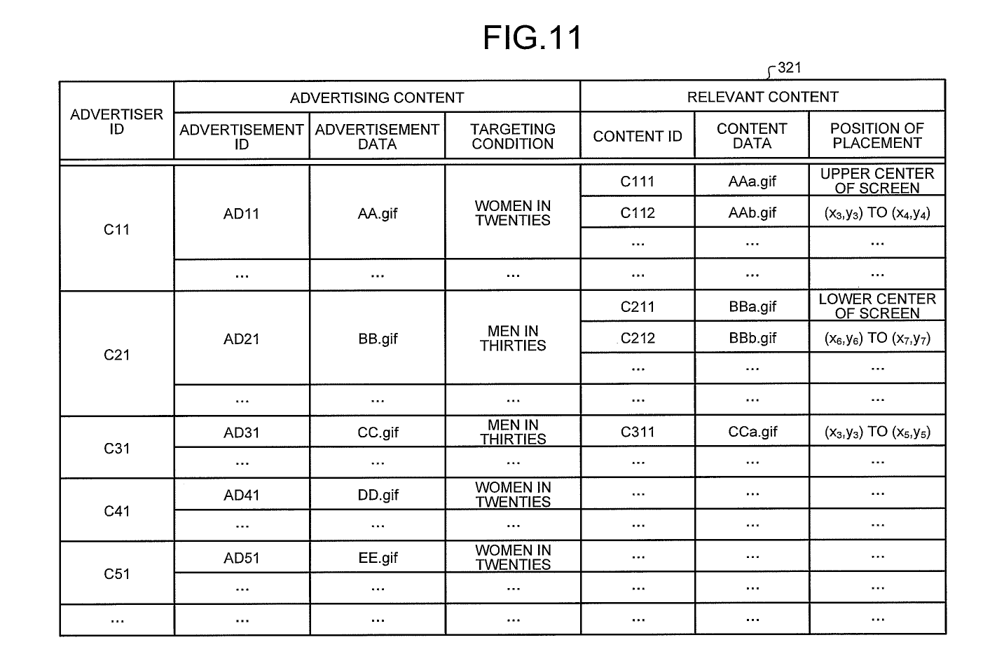

The advertising content storing unit 321 is used to store a variety of information related to the advertising contents and the relevant contents submitted from the advertiser terminal 5. In FIG. 11 is illustrated an example of the advertising content storing unit 321 according to the modification example. In the example illustrated in FIG. 11, the advertising content storing unit 321 is used to store the same information as stored in the advertising content storing unit 221 as well as to store items such as “content ID”, “content data”, and “placement position” as information related to the relevant contents.

The “content ID” represents identification information enabling identification of the relevant content submitted from the advertiser terminal 5. The “content data” represents data of the relevant content that has a smaller display size than the size of the display unit 130 and that is displayed in an overlapping manner on the advertising content. In practice, such a relevant content represents a still image or a moving image. The “placement position” represents information specifying the position of placement of the relevant content when placed in an overlapping manner on the advertising content. For example, as the position of placement on the display unit 130, information such as “upper center of screen” is set. Alternatively, as the position of placement on the advertising content, predetermined coordinates are set.

Thus, in FIG. 11 is illustrated an example in which the advertiser identified by the advertiser ID “C11” submits the advertising content AD11 and submits image data “AAa.gif” of a relevant content identified by a content ID “C111”, and specifies to display the relevant content at the “upper center of screen” of the display unit 130.

Given below is the explanation of display control performed by the display control unit 143 of the terminal device 100 with respect to an advertising content and a relevant content. Firstly, as described earlier, according to a user operation, when a webpage received from the contents server device 20 includes an advertisement acquisition request, the terminal device 100 sends an advertisement request to the advertisement server device 300. Then, from the advertisement server device 300 that received the advertisement request; the terminal device 100 receives control information, an advertising content, and a relevant content. Then, according to the instructions specified in the control information, the display control unit 143 of the terminal device 100 controls the display format of the advertising content and the relevant content.

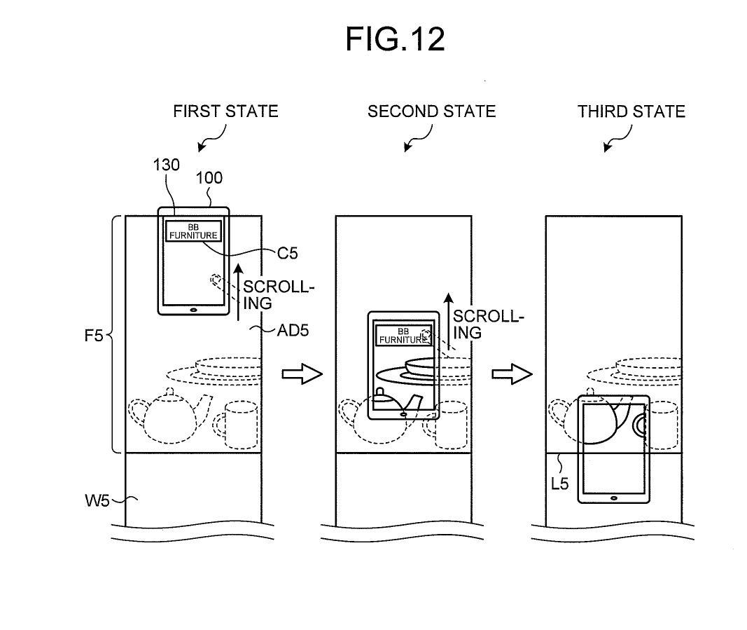

More particularly, the display control unit 143 displays the relevant content in an overlapping manner on the advertising content and within the screen of the display unit 130. For example, the display control unit 143 displays the relevant content in an overlapping manner on the advertising content and in a fixed manner at a predetermined position on the display unit 130. The related explanation is given with reference to FIG. 12.

FIG. 12 is a diagram illustrating an example of the display control performed in the case of displaying a relevant content in an overlapping manner on an advertising content. For example, assume that a webpage W5 having an advertising space F5 positioned at the upper end thereof as illustrated in (A) in FIG. 4 is received from the contents server device 20. Moreover, assume that, as the advertising content to be put in the advertising space F5, the terminal device 100 receives an advertising content AD5 containing control information and receives a relevant content C5. Furthermore, assume that the received relevant content C5 is a logo image symbolizing the advertiser (a store or a business enterprise) that submitted the advertising content AD5.

Since the advertising content AD5 is put in the advertising space F5 and since the advertising space F5 is positioned at the upper end of the webpage W5, the display control unit 143 firstly performs the initial display of the advertising content AD5 on the display unit 130. At that time, the display control unit 143 performs display control in such a way that the relevant content C5 is displayed in an overlapping manner on the advertising content AD5 and in a fixed manner at a predetermined position on the display unit 130. In FIG. 12 is illustrated an example in which the relevant content C5 is displayed at the center of the uppermost part of the screen of the display unit 130. However, that is not the only possible case, and the relevant content C5 can be displayed at an arbitrary position. For example, the relevant content C5 can be displayed at the center of the lowermost part of the display unit 130. That display position is, for example, set in advance by either the advertiser or the administrator of the terminal device 100.

Herein, assume that the user performs upward scrolling in the first state so that the display state of the advertising content AD5 on the display unit 130 changes to the second state. In such a case too, because of the display control performed by the display control unit 143, the relevant content C5 is displayed in a fixed manner at the center of the uppermost part of the display unit 130. Thus, unlike the advertising content AD5, the relevant content C5 does not move in response to scrolling.

As a result, the terminal device 100 can display such information which is to be particularly brought to the attention of the user on the terminal screen on a constant basis. That enables achieving enhancement in the advertisement effectiveness.

Meanwhile, based on the display format of the advertising content on the display unit 130, the display control unit 143 can perform display control to switch between displaying the relevant content and hiding the relevant content. More particularly, the display control unit 143 detects the display format of the advertising content on the display unit 130 and, when the display format changes to a predetermined state, switches between displaying the relevant content and hiding the relevant content.

For example, assume that the user performs upward scrolling in the second state illustrated in FIG. 12 so that the display state of the advertising content on the display unit 130 changes to a third state. In the third state illustrated in FIG. 12, because of the upward scrolling performed by the user, a boundary line L5 between the advertising content AD5 and the webpage W5 is positioned at the center of the display unit 130, that is, positioned at the midpoint in the vertical direction of the display unit 130. Hence, the advertising content AD5 is displayed in half of the dimension of the display unit 130.

When it is detected that the display format of the advertising content AD5 on the display unit 130 has changed to the third state; the display control unit 143 switches between displaying the relevant content C5 and hiding the relevant content C5. In FIG. 12, the advertising content AD5 as well as the relevant content C5 is displayed in the initial display. Hence, when the third state is detected, the display control unit 143 hides the relevant content C5.

As illustrated in (B) in FIG. 4, when an advertising space is inserted in a webpage, even if scrolling by the user results in displaying the advertising content on the display unit 130, the display control unit 143 can detect the third state illustrated in FIG. 12 according to the scrolling of the advertising content and the webpage and can switch between displaying the relevant content and hiding the relevant content.

Herein, if the boundary line between an advertising content and the webpage is detected to be positioned at the center of the display unit 130; then the display control unit 143 switches between displaying the relevant content and hiding the relevant content. However, that is not the only possible case. Alternatively, for example, the setting can be such that, if the boundary line between an advertising content and the webpage is detected to be positioned at a predetermined position of the display unit 130, the display control unit 143 switches between displaying the relevant content and hiding the relevant content. Still alternatively, instead of performing detection based on the boundary line, for example, the display control unit 143 can continuously go on calculating the dimension of the advertising content displayed on the display unit 130; and switch between displaying the relevant content and hiding the relevant content based on the ratio of the dimension of the advertising content with respect to the dimension of the display unit 130. More particularly, a predetermined threshold value is set for the ratio, and the display control unit 143 displays the relevant content when the ratio is equal to or greater than the threshold value but hides the relevant content when the ratio is smaller than the threshold value.

6-2. Relevant Content (2)

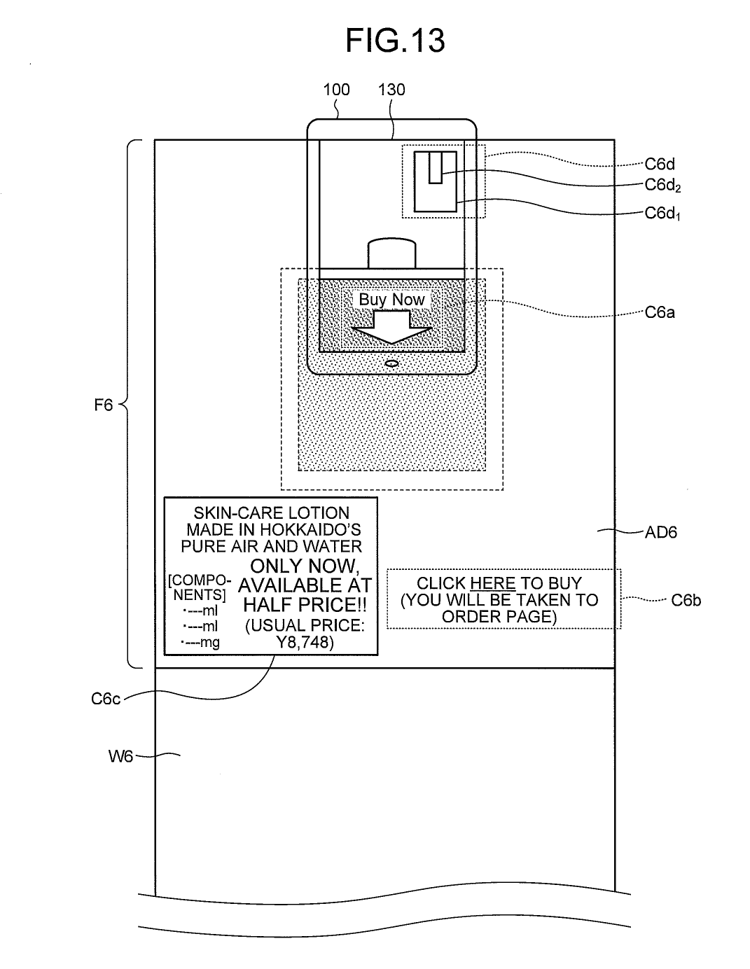

In addition to receiving an advertising content having the display size bigger than the size of the display unit 130 from the advertisement server device 300, the terminal device 100 described above can also receive relevant content that has a smaller display size than the size of the display unit 130 and that represents information for guiding the user to a predetermined position in the advertising content. Then, the display control unit 143 displays the relevant content in an overlapping manner on the advertising content in such a way that the user is guided to a predetermined position. The related explanation is given with reference to FIG. 13.

FIG. 13 is a diagram illustrating an example of the display format in the case of displaying a relevant content in an overlapping manner on an advertising content. For example, assume that the terminal device 100 receives, from the contents server device 20, a webpage W6 having an advertising space F6 positioned at the upper end thereof as illustrated in (A) in FIG. 4. Moreover, assume that the terminal device 100 receives an advertising content AD6 containing control information and receives a relevant content C6a according to an advertisement acquisition request included in the webpage W6. The relevant content C6a represents information for guiding the user to a predetermined position in the advertising content AD6. In FIG. 13 is illustrated an example in which the relevant content C6a represents an image formed by combining “Buy Now” and “arrow image”.

Then, as illustrated in FIG. 13, for example, if the advertiser has specified the position of placement of the relevant content C6a on the display unit 130, then the display control unit 143 puts the advertising content AD6 in the advertising space F6 and displays the relevant content C6a based on the specified position of placement and in an overlapping manner on the advertising content AD6. Although it is desirable that such information for guiding the user to a predetermined position in the advertising content is fixed with respect to the display unit 130 as explained in the modification example 6-1, it is not the only possible case. Alternatively, for example, if the advertiser specifies the position of placement (coordinates) with respect to the advertising content AD6, then the display control unit 143 can display the relevant content C6a at the specified position of placement. Moreover, the operation related to displaying and hiding as explained in the modification example 6-1 can be implemented for the relevant content C6a too.

Herein, the explanation is given for an example in which the relevant content representing information for guiding the user to a predetermined position in the advertising content is displayed in an overlapping manner on the advertising content. Alternatively, the display control unit 143 can move the advertising content toward a predetermined position therein. For example, when it is detected that the advertising content is displayed on the display unit 130, the display control unit 143 automatically scrolls the advertising content in such a way that the user is guided to the predetermined position in the advertising content.

For example, it is thinkable that, since the display size of the advertising content is greater than the size of the display unit 130, the position in the advertising content at which important information is written cannot be understood at a glance. In such a case, the terminal device 100 can use guiding information as the relevant content and guide the user to the predetermined position in the advertising content without leading the user wrong. That enables achieving enhancement in the usability.

6-3. Relevant Content (3)

In addition to receiving an advertising content having the display size bigger than the size of the display unit 130 from the advertisement server device 300, the terminal device 100 described above can also receive a relevant content that has a smaller display size than the size of the display unit 130 and that represents buying information, or detailed information, or coupons of the product related to the advertising content. Then, the display control unit 143 displays the relevant content in an overlapping manner on the advertising content. The related explanation is given with reference to FIG. 13.

In the modification example 6-2, the terminal device 100 receives the advertising content AD6 containing control information and receives the relevant content C6a from the advertisement server device 300. In contrast, herein, it is assumed that relevant contents C6b and C6c are received. The relevant contents C6b and C6c represent buying information and detailed information of the product related to the advertising content AD6. However, the relevant contents C6b and C6c are not limited to represent buying information and detailed information, and can alternatively be coupon information, for example.

Then, as illustrated in FIG. 13, if the advertiser has specified the positions of placement for the relevant contents C6b and C6c, then the display control unit 143 puts the advertising content AD6 in the advertising space F6 and displays the relevant contents C6b and C6c based on the specified positions of placement and in an overlapping manner on the advertising content AD6. Such buying information and detailed information either can be fixed with respect to the display unit 130 as explained in the modification example 6-1, or can be placed at the positions of placement specified in the advertising content AD6.

In this way, by placing a relevant content such as detailed information on an advertising content, the terminal device 100 can enrich the details of that advertising content. That enables achieving enhancement in the degree of satisfaction of the user with respect to the advertising content.

6-4. Relevant Content (4)

The display control unit 143 can display, in an overlapping manner on an advertising content, information indicating the current position of display of the advertising content on the display unit 130. The information indicating the current position of display of the advertising content on the display unit 130 is smaller than the size of the display unit 130 and is referred to as a relevant content C6d. Regarding the relevant content C6d, the explanation is given with reference to FIG. 13.

As illustrated in FIG. 13, the relevant content C6d is made of a frame C6d₁, which is formed by downscaling the shape of the advertising space F6 in which the advertising content AD6 is put, and a frame C6d₂, which is formed by downscaling the shape of the display unit 130. Then, the frame 6d₂ moves according to scrolling and indicates the current position of display of the advertising content on the display unit 130. The display control unit 143 displays the relevant content C6d in an overlapping manner on the advertising content D6. Herein, although the display control unit 143 can be set to display the relevant content C6d in a fixed manner at an arbitrary position on the display unit 130, it is desirable that the set position does not hinder the visibility of the advertising content. Moreover, the operation related to displaying and hiding as explained in the modification example 6-1 can be implemented for the relevant content C6d too.

For example, since the display size of an advertising content is greater than the size of the display unit 130, there are times when it is difficult to understand the position in the advertising content that is currently being displayed. In regard to such a case, since the terminal device 100 can display information indicating the current position of display of the advertising content, enhancement in the usability can be achieved.

6-5. Initial Display Position of Advertising Content

In the embodiment described above, the explanation is given for an example in which the advertising space is placed at the upper end of a webpage as illustrated in (A) in FIG. 4 and, in the case of performing the initial display of an advertising content, the display control unit 143 sets the center of the uppermost part of the advertising content as the initial display position. However, alternatively, the display control unit 143 can display the advertising content based on information related to the initial display position.

The display control unit 143 refers to the information obtained by the obtaining unit 144 of the terminal device 100 as the information related to the initial display position and determines the initial display position; and performs the initial display of an advertising content based on the determined initial display position. As described earlier, if a web camera is installed in the terminal device 100, then the obtaining unit 144 obtains the visual confirmation rates from the visual confirmation area of the user with respect to the advertising content displayed on the display unit 130.

There, for example, the display control unit 143 determines the visual confirmation area having the highest visual confirmation rate, from among the visual confirmation rates obtained by the obtaining unit 144, as the initial display position. Then, while performing the initial display of the advertising content, the display control unit 143 displays the determined initial display position.

Meanwhile, the display control unit 143 need not always determine the initial display position based on the visual confirmation rates obtained by the obtaining unit 144. Alternatively, the display control unit 143 can determine the initial display position by referring to some other information obtained by the obtaining unit 144. For example, the display control unit 143 can determine, as the initial display position, either the area having the longest display period or the area having the highest display count due to scrolling from among the areas which are obtained by the obtaining unit 144 and in which the advertising content is displayed in the display unit 130.

Meanwhile, the display control unit 143 can set an advertiser-specified position as the initial display position. In that case, the terminal device 100 receives in advance the information related to the initial display position from the advertiser, and the display control unit 143 displays the received initial display position.

As a result, for example, regarding the positions in the advertising content that are believed to be of interest to the user, the terminal device 100 can force the user to visually confirm those positions, thereby enabling achieving enhancement in the advertisement effectiveness.

6-6. Background Advertising Content

The terminal device 100 can receive, from an advertisement server device, an advertising content that has a bigger display size than the size of the display unit 130 and that is displayed as the background of a webpage. Then, the display control unit 143 of the terminal device 100 displays a predetermined webpage in a transparently overlapping manner on the received advertising content, and sets the advertising content as the background of that webpage.

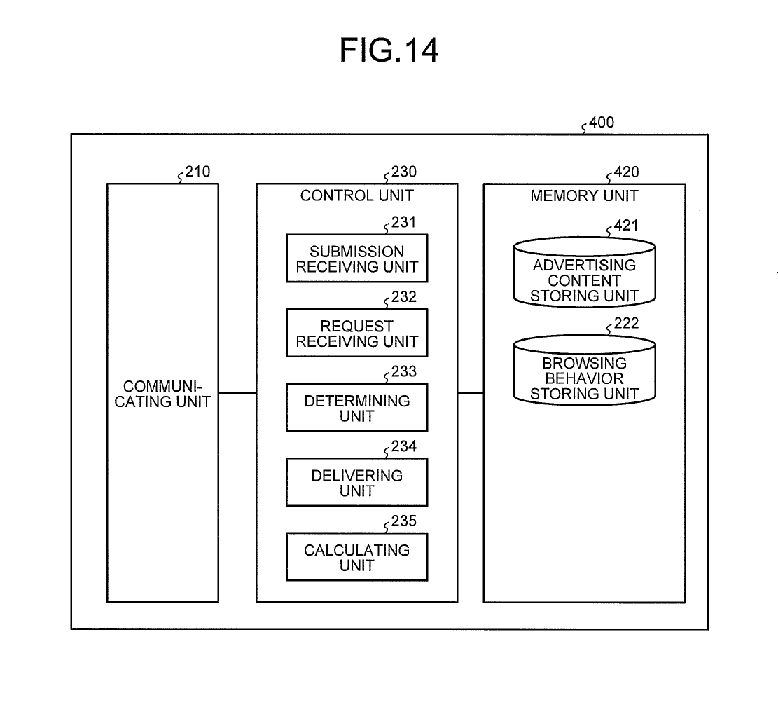

Such advertising content serving as the background (in the following explanation, sometimes written as a “background advertisement”) is assumed to be submitted along with bid information by an advertiser to an advertisement server device 400. Firstly, the explanation is given about a configuration of the advertisement server device 400 according to a modification example. FIG. 14 is a diagram illustrating a configuration of the advertisement server device 400 according to the modification example. The advertisement server device 400 includes an advertising content storing unit 421 that is used to store different information than the information stored in the advertising content storing unit 221 illustrated in FIGS. 6 and 7. Aside from that, the advertisement server device 400 includes the same constituent elements as those in the advertisement server device 200. Hence, that explanation is not repeated.

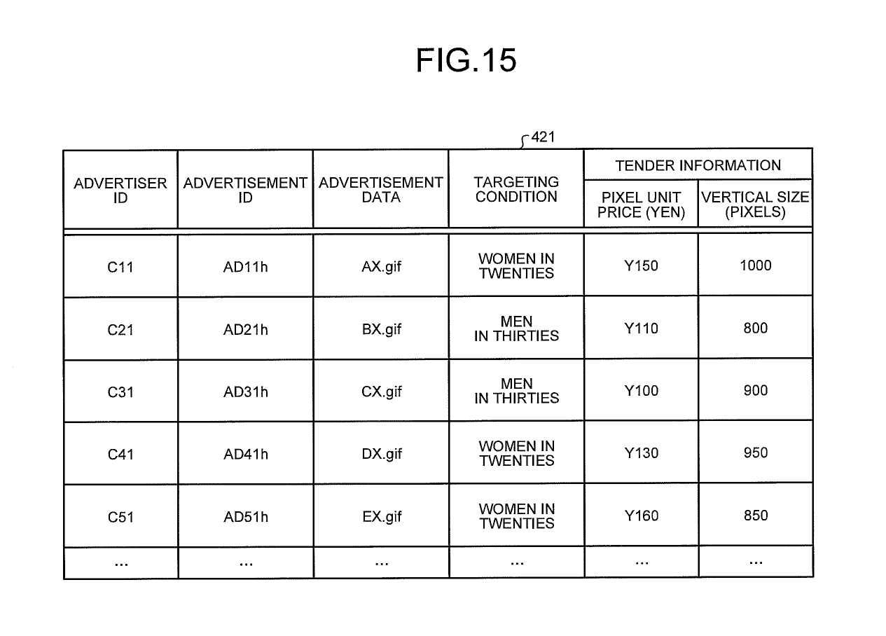

The advertising content storing unit 421 is used to store a variety of information related to background advertising contents of predetermined webpages submitted from the advertiser terminal 5. In FIG. 15 is illustrated an example of the advertising content storing unit 421 according to the modification example. In the example illustrated in FIG. 15, the advertising content storing unit 421 includes items such as “advertiser ID”, “advertisement ID”, “advertisement data”, and “targeting condition”; as well as includes items such as “pixel unit price” and “vertical size” as bid information. The “advertiser ID”, the “advertisement ID”, the “advertisement data”, and the “targeting condition” are identical to those in the explanation given about the advertising content storing unit 221 illustrated in FIG. 7.

The bid information is set by the advertiser, and the “pixel unit price” represents the price per unit pixel in a background advertisement submitted by an advertiser. For example, the “pixel unit price” can be the unit price per unit pixel with respect to the pixel amount in the vertical direction in the background advertisement displayed on the display unit 130, or can be the unit price per unit pixel with respect to the pixel amount in the horizontal direction in the background advertisement displayed on the display unit 130. Alternatively, the “pixel unit price” can be the unit price per unit pixel with respect to the dimension of the background advertisement displayed on the display unit 130. Meanwhile, a unit pixel need not always be a single pixel, but can alternatively be two pixels or three pixels, for example. The “vertical size” represents the vertical size (the length in the vertical direction) of the advertising content displayed on the display unit 130. For example, when an advertiser specifies “1000 pixels” as the vertical size, the data of the advertising content submitted by that advertiser is displayed with the vertical size of “1000 pixels”.

In FIG. 15 is illustrated an example in which the advertiser identified by the advertiser ID “C11” submits image data “AX.gif” of a background advertisement identified by an advertisement ID “AD11h”; as well as specifies the targeting condition “women in twenties”, specifies the pixel unit price “Y150”, and specifies the vertical size “100 pixels”.

Given below is the explanation about an advertisement operation related to background advertisements. Firstly, when an advertisement request is received from the terminal device 100, the determining unit 233 of the advertisement server device 400 determines background advertisements to be delivered to the terminal device 100 and determines the sequence of display on the display unit 130 according to the movement operations such as scrolling with respect to the background advertisements to be delivered. More particularly, when the request receiving unit 232 receives an advertisement request from the terminal device 100, the determining unit 233 accesses the advertising content storing unit 421 and determines the background advertisements to be delivered and the sequence of display thereof based on the bid information.

As illustrated in FIG. 15, the bid information contains the “pixel unit price” and the “vertical size”. Thus, for example, the determining unit 233 narrows down the background advertisements according to the targeting condition, and then determines the sequence of display of the advertising contents to be displayed based on the pixel price value or based on the pixel price value and the vertical size. For example, in the case of determining the advertising content to be delivered based on the pixel unit price, the determining unit 233 determines the background advertisements having a high pixel unit price as the target for delivery on priority and determines the sequence of display of those background advertisements according to the pixel unit prices. On the other hand, for example, in the case of determining the advertising contents to be delivered based on the pixel unit price and the vertical size, the determining unit 233 determines the background advertisements having a high value obtained by multiplying the pixel unit price and the vertical size as the target for delivery on priority and determines the sequence of display of those background advertisements according to the multiplication values. In this modification example, the explanation is given for an example in which the determining unit 233 determines the background advertisements to be delivered and the sequence of display based on the pixel unit prices. Moreover, the explanation is given under the assumption that the determining unit 233 is set to determine two background advertisements to be delivered. However, the number of background advertisements determined to be delivered is not limited to two, and can be set in an arbitrary manner. For example, only a single background advertisement can be determined, or three background advertisements can be determined.

For example, assume that the determining unit 233 obtains a user attribute “women in twenties” based on the user ID of the terminal device 100 that issued an advertisement request. Then, the determining unit 233 matches the user attribute “women in twenties” with the targeting condition and selects background advertisements AD11h, AD41h, and AD51h. As the top two background advertisements having a high pixel unit price, the determining unit 233 determines the background advertisements AD11h and AD51h as the background advertisements to be delivered; and determines “1” as the sequence of display for the background advertisement AD51h having the higher pixel unit price and determines “2” as the sequence of display for the background advertisement AD11h having the lower pixel unit price. Then, the delivering unit 234 associates the background advertisements and the sequence of display as determined by the determining unit 233, and delivers that information along with control information to the terminal device 100.

Given below is the explanation of the display control performed by the display control unit 143 of the terminal device 100. The display control unit 143 displays a predetermined webpage in a transparently overlapping manner on the received advertising content, and sets the advertising content as the background of that webpage.

For example, assume that the terminal device 100 receives a webpage W7 in response to a page request. The webpage W7 has a smaller horizontal size than the horizontal size of the display unit 130 but has a greater vertical size than the vertical size of the display unit 130. Moreover, for example, the webpage W7 is either displayed on the display unit 130 or hidden from the display unit 130 according to vertical scrolling performed by the user. Furthermore, the entire area of the webpage W7 is set as a transparent area that can be made transparent.

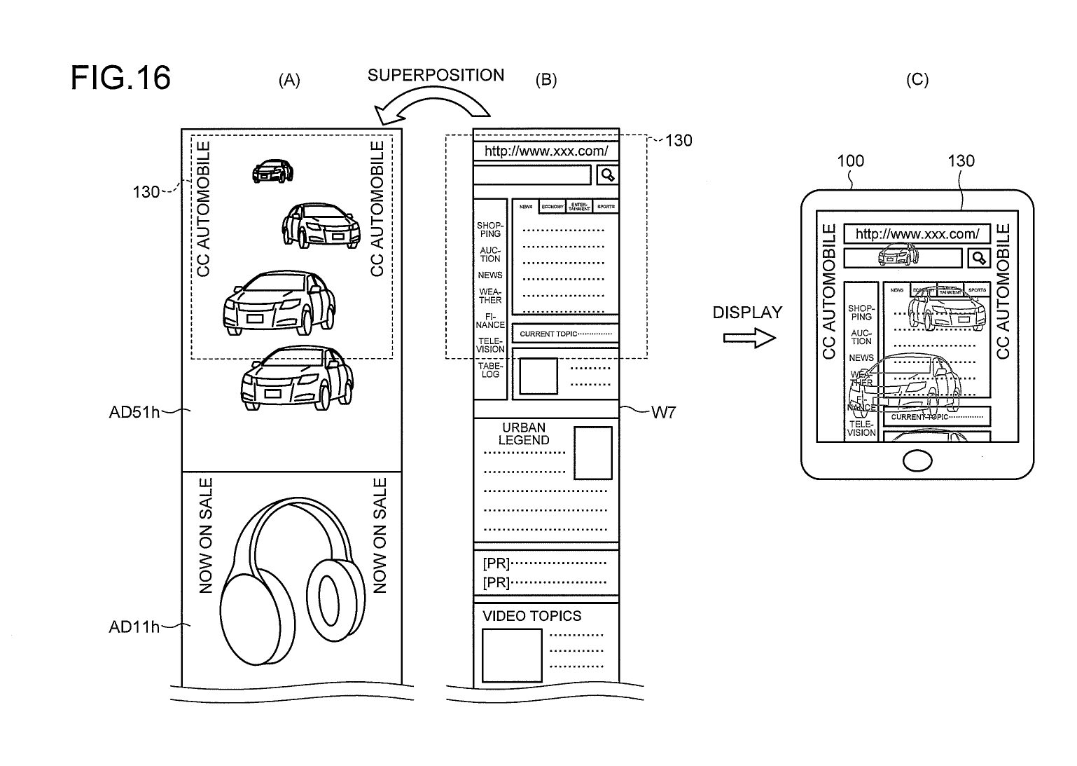

Then, assume that the terminal device 100 receives the background advertisements AD11h and AD51h assigned with the sequence of display as a result of the determination operation performed by the determining unit 233, and receives control information. With that, the display control unit 143 performs the display control. The related explanation is given with reference to FIG. 16.

FIG. 16 is a diagram for explaining the display control performed to display a webpage in a transparently overlapping manner on an advertising content. Herein, the webpage W7 is displayed on or hidden from the display unit 130 according to the vertical scrolling. Hence, the display control unit 143 displays the background advertisement AD51h at the upper side and displays the background advertisement AD11h at the lower side so that sequence of display is followed; connects the two background advertisements AD51h and AD11h; and overlaps the webpage W7 in a transparent manner on the background advertisements AD51h and AD11h. Then, as illustrated in (C) in FIG. 16, the display control unit 143 displays, on the display unit 130, the data in which the webpage W7 is transparently overlapped on the background advertisements. Meanwhile, in (A) and (B) in FIG. 16, the dotted area represents the display unit 130.

In (C) in FIG. 16 is illustrated an example in which, since the advertising content AD51h has a greater horizontal size than the horizontal size of the webpage W7, such portion of the advertising content AD51h which is not included in the scope of the webpage W7 (i.e., the portion including CC automobile) is not displayed as the background of the webpage W7 but is displayed as it is. However, that is not the only possible case. Alternatively, for example, the display control unit 143 can overlap the webpage W7 in a non-transparent manner on the advertising content AD51h, so that only such portion of the advertising content AD51h which is not included in the scope of the webpage W7 is displayed. Still alternatively, for example, if the horizontal size of an advertising content matches with the horizontal size of a webpage, then the display control unit 143 can display the entire advertising content as the background of the webpage. Still alternatively, for example, if the horizontal size of an advertising content is greater than the horizontal size of a webpage and if the horizontal size of the webpage matches with the horizontal size of the display unit 130, then the display control unit 143 can perform the display control in such a way that the portion of the advertising content which is included in the scope of the webpage is displayed as the background and the portion of the advertising content which is not included in the scope of the webpage is displayed as a normal advertising content in response to scrolling.

Meanwhile, although the explanation is given for an example in which the display control unit 143 displays a webpage in a transparently overlapping manner on an advertising content, the display control unit 143 can also perform the operation in the other way round. More particularly, the display control unit 143 can display an advertising content in a transparently overlapping manner on a webpage.

In FIG. 16 is illustrated an example in which a plurality of background advertisements is set in a single webpage. Alternatively, for example, as described earlier, the number of background advertisements in the terminal device 100 can be set to one, so that a model can be used in which the background of a single webpage is bought up by a single advertiser.

In this way, the terminal device 100 displays an advertising content as the background of a webpage. As a result, the terminal device 100 can make the user pay attention to the advertising content as a natural extension to browsing the webpage. That enables achieving enhancement in the advertisement effectiveness.

6-7. Sequence of Display and Delivery Operation

In the modification example 6-6, the explanation is given for an example in which, based on the “pixel unit price” and the “vertical size”, the determining unit 233 of the advertisement server device 400 determines the background advertisements and determines the sequence of display according to the movement of the background advertisements. Alternatively, the determining unit 233 can perform the determination operation with respect to advertising contents other than the background advertising contents, that is, with respect to advertising contents that are placed at the upper end, or placed at the lower end, or inserted in a webpage in the same plane as the webpage as explained in the embodiment and that have a bigger display size than the size of the display unit 130. In such a case, the premise is that a single webpage includes a plurality of advertising spaces. Moreover, it is necessary that the advertisers specify the “pixel unit price” and the “vertical size” with respect to the respective advertising contents.

Then, the delivering unit 234 delivers the advertising contents, which are determined by the determining unit 233, to the terminal device 100 in such a way that the advertising contents are displayed according to the sequence of display determined by the determining unit 233. Given below is the explanation of the delivery operation performed by the delivering unit 234.

More particularly, the delivering unit 234 associates the advertising contents and the sequence of display as determined by the determining unit 233, and delivers that information to the terminal device 100. For example, assume that a webpage W8 obtained in response to a page request from the terminal device 100 includes two advertising spaces and accordingly the determining unit 233 determines “advertising content: AD8, sequence of display: 1” and “advertising content: AD9, sequence of display: 2” as the advertising contents to be delivered and the sequence of display thereof. Then, the delivering unit 234 associates the data of the advertising content AD8 with “1” as the sequence of display, associates the data of the advertising content AD9 with “2” as the sequence of display, and delivers that information to the terminal device 100.

Meanwhile, to the contents server device 20 to which the advertising contents are delivered along with the webpage in which the advertising contents are displayed according to the sequence of display determined by the determining unit 233, the delivering unit 234 can deliver the advertising contents and the sequence of display as determined by the determining unit 233. That point is explained below.

For example, assume that the webpage W8 obtained in response to a page request from the terminal device 100 includes two advertising spaces and accordingly the determining unit 233 determines “advertising content: AD8, sequence of display: 1” and “advertising content: AD9, sequence of display: 2” as the advertising contents to be delivered and the sequence of display thereof. Then, the delivering unit 234 associates the data of the advertising content AD8 with “1” as the sequence of display, associates the data of the advertising content AD9 with “2” as the sequence of display, and delivers that information to the contents server device 20. Upon receiving the advertising contents and the sequence of display thereof, in response to the initial display or a movement operation such as scrolling, the contents server device 20 puts the advertising content AD8 having “1” as the sequence of display in the advertising space displayed in the first place on the display unit 130 (i.e., the topmost advertising space from among the advertising spaces in the webpage W8) and puts the advertising content AD9 having the “2” as the sequence of display in the advertising space displayed subsequently on the display unit 130. Then, the contents server device 20 delivers the webpage W8, in which the advertising contents are put, to the terminal device 100.

Meanwhile, every time an advertising content becomes a target for display on the display unit 130, the delivering unit 234 receives a request for that advertising content as issued by the terminal device 100, and can deliver the advertising content in response to the received request. That point is described below.

For example, assume that the webpage W8 obtained in response to a page request from the terminal device 100 includes two advertising spaces and accordingly the determining unit 233 determines “advertising content: AD8, sequence of display: 1” and “advertising content: AD9, sequence of display: 2” as the advertising contents to be delivered and the sequence of display thereof. Then, the delivering unit 234 associates the data of the advertising content having the highest sequence of display, that is, the advertising content AD8 having “1” as the sequence of display with the sequence of display, and delivers that information to the terminal device 100.

When the terminal device 100 receives the advertising content AD8, the display control unit 143 puts the advertising content AD8 in the advertising space that is displayed in the first place on the display unit 130 in response to the initial display or a movement operation such as scrolling. Herein, it is assumed that the advertising content AD8 is displayed on the entire display unit 130 at present. Then, for example, due to upward scrolling, the advertising content AD8 is moved. When the lower end of the advertising content AD8 is no more visible on the display unit 130, the display control unit 143 instructs the requesting unit 141 to request delivery of the advertising content to be put in the advertising space provided below the advertising space in which the advertising content AD8 was put, that is, to request delivery of the advertising content having “2” as the sequence of display as the advertising content to be displayed.

Upon receiving the instruction from the display control unit 143, the requesting unit 141 sends an advertisement request to the advertisement server device 200. When the advertisement server device 200 receives the advertisement request from the terminal device 100, the delivering unit 234 delivers the advertising content AD9 having “2” as the sequence of display as determined by the determining unit 233 to the terminal device 100. Once the terminal device 100 receives the advertising content AD9, the display control unit 143 puts the advertising content AD9 in the corresponding advertising space.

Herein, although the delivery operation performed by the delivering unit 234 is explained with reference to a webpage including two advertising spaces, the number of advertising spaces is not limited to two. Alternatively, for example, if a webpage including three advertising spaces is received by the terminal device 100, then the display control unit 143 performs display control also with respect to the third advertising content from the top. When the advertisement server device 200 receives an advertisement request issued as a result of the display control; the delivering unit 234 delivers, to the terminal device 100, the advertising content having “3” the sequence of display as determined by the determining unit 233.

Herein, the explanation is given for an example in which, when the lower end of an advertising content is no more visible on the display unit 130 due to upward scrolling, the display control unit 143 treats the advertising content having a lower sequence of display (for example, having the sequence of display lower by one) as the target for display. On the other hand, when downward scrolling is performed, if the upper end of an advertising content is no more visible on the display unit 130, the display control unit 143 can treat the advertising content having a higher sequence of display as the target for display. Meanwhile, regarding the timing of instructing delivery of the advertising content to be displayed, the display control unit 143 need not set that timing according to whether or not the upper end or the lower end of the advertising content is no more visible on the display unit 130. Alternatively, for example, the display control unit 143 can issue an instruction based on the timing at which a predetermined distance from the upper end or the lower end becomes visible on the display unit 130 or can issue an instruction based on the dimension.

Meanwhile, although the explanation is given for an example in which the display control unit 143 receives advertising contents and the sequence of display thereof from the delivering unit 234 and instructs the sequence of display of the advertising contents to be delivered, that is not the only possible case. Alternatively, for example, the sequence of display can be associated in advance to the advertising spaces. Then, based on the sequence of display associated in advance to the advertising spaces, the display control unit 143 can instruct the advertising contents to be displayed.

6-8. Sequence of Display Based on Story Nature

The explanation is given for an example in which, the determining unit 233 of the advertisement server device 400 determines the sequence of display of a plurality of advertising contents, which is to be delivered, based on the bid information. Alternatively, the determining unit 233 can determine a plurality of advertising contents to be delivered and the sequence of display thereof in such a way that a predetermined story nature is developed when the advertising contents are displayed due to scrolling. For that reason, the advertisement server device 400 receives the submission of advertising contents from an advertiser as well as receives the categories of the advertising contents to be submitted. Meanwhile, the advertisement server device 400 can receive the categories by input or selection. Herein, the categories can be set by the administrator of the advertisement server device 400.

Then, the determining unit 233 compares the categories, and selects a predetermined number of advertising contents related to each other by the categories having a high degree of association. For example, if the number of advertising contents to be displayed is set to two, then the determining unit 233 selects advertising contents having mutual association. For example, it is possible to think that the determining unit 233 selects an advertising content that is assigned with a category “skiing shop” and an advertising content that is assigned with a category “tour information (skiing)”.

Then, the determining unit 233 associates the advertising content assigned with the category “skiing shop” with “1” as the sequence of display, associates the advertising content assigned with the category “tour information (skiing)” with “2” as the sequence of display, and instructs the delivering unit 234 to deliver the information to the terminal device 100.

Then, based on the received sequence of display, the display control unit 143 of the terminal device 100 performs display control with respect to the advertising contents. As a result, for example, due to scrolling, the display of the advertising content assigned with the category “skiing shop” is followed by the display of the advertising content assigned with the category “tour information (skiing)”. With that, there develops a story nature from the advertising content related to a skiing shop to the advertising content related to skiing tour information.

6-9. Another Type of Display Control

The display control unit 143 of the terminal device 100 can display a skip button, which is used for skipping advertising contents and moving to the webpage, as a relevant content in a fixed manner at a predetermined position. As a result, the terminal device 100 can ensure that the display of advertising contents does not hinder the users who are not interested in the advertising contents.

6-10. Device Configuration

In the embodiment described above, the explanation is given for an example in which the control information is delivered from the advertisement server device 200 to the terminal device 100. Alternatively, the control information can delivered from the contents server device 20 to the terminal device 100. Moreover, the explanation given above is about an example in which the terminal device 100 receives the control information and performs control such as display control according to the instructions specified in the received control information. Alternatively, a computer program for performing control based on the control information can be installed in advance in the terminal device 100. Meanwhile, the contents server device 20 and the advertisement server device 200 can be integrated into a single device.

6-11. Hardware Configuration

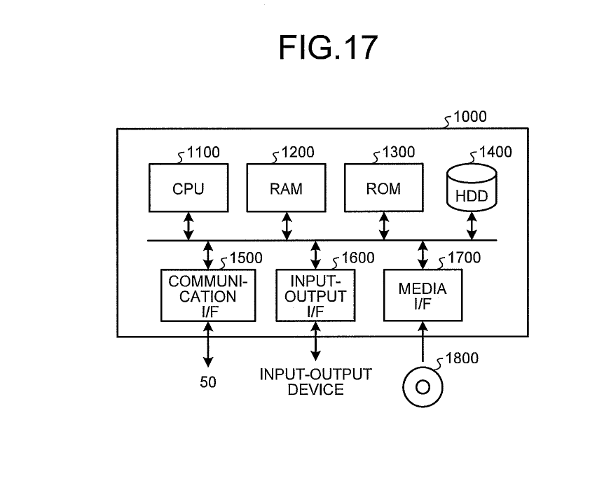

The terminal device 100 and the advertisement server device 200 according to the embodiment are implemented using, for example, a computer 1000 having a configuration illustrated in FIG. 17. The following explanation is given regarding the terminal device 100. FIG. 17 is a diagram illustrating an exemplary hardware configuration of the computer 1000 that implements the functions of the terminal device 100. The computer 1000 includes a CPU 1100, a RAM 1200, a read only memory (ROM) 1300, a hard disk drive (HDD) 1400, a communication interface (I/F) 1500, an input-output interface (I/F) 1600, and a media interface (I/F) 1700.

The CPU 1100 performs operations and controls the constituent elements based on computer programs stored in the ROM 1300 or the HDD 1400. The ROM 1300 is used to store a boot program that is executed by the CPU 1100 at the time of booting of the computer 1000, and to store computer programs dependent on the hardware of the computer 1000.

The HDD 1400 is used to store computer programs executed by the CPU 1100 and to store data used in the computer programs. The communication interface 1500 receives data from other devices via a communication network 50 (that corresponds to the network N) and sends the received data to the CPU 1100, and sends the data generated by the CPU 1100 to other devices via the communication network 50.

The CPU 1100 controls output devices, such as a display and a printer, and input devices, such as a keyboard and a mouse, via the input-output interface 1600. Moreover, the CPU 1100 obtains data from the input devices via the input-output interface 1600. Furthermore, the CPU 1100 outputs the generated data to the output devices via the input-output interface 1600.

The media interface 1700 reads computer programs and data from a recording medium 1800, and provides them to the CPU 1100 via the RAM 1200. Thus, the CPU 1100 loads the computer programs from the recording medium 1800 into the RAM 1200 via the media interface 1700, and executes the loaded computer programs. For example, the recording medium 1800 is an optical recording medium such as a digital versatile disc (DVD) or a phase change rewritable disk (PD); or a magneto-optical recording medium (MO); or a tape medium; or a magnetic recording medium; or a semiconductor memory.

For example, when the computer 1000 functions as the advertisement server device 200 according to the embodiment, the CPU 1100 of the computer 1000 executes the computer programs loaded into the RAM 1200 and implements the functions of the control unit 230. The HDD 1400 is used to store data that is stored in the memory unit 220. Herein, the CPU 1100 of the computer 1000 reads the computer programs from the recording medium 1800 and executes them. However, as another example, the CPU 1100 can obtain the computer programs from another device via the communication network 50.

Meanwhile, when the computer 1000 functions as the terminal device 100 according to the embodiment, the CPU 1100 of the computer 1000 executes the computer programs loaded into the RAM 1200 and implements the functions of the control unit 140.

7. Other

Of the processes described in the embodiments, all or part of the processes explained as being performed automatically can be performed manually. Similarly, all or part of the processes explained as being performed manually can be performed automatically by a known method. The processing procedures, the control procedures, specific names, various data, and information including parameters described in the embodiments or illustrated in the drawings can be changed as required unless otherwise specified. For example, the variety of information illustrated in the drawings is not limited to that information.

Moreover, the constituent elements of each device illustrated in the drawings are merely conceptual, and need not be physically configured as illustrated. The constituent elements, as a whole or in part, can be separated or integrated either functionally or physically based on various types of loads or use conditions. For example, the requesting unit 141 and the receiving unit 142 illustrated in FIG. 3 can be integrated.

Furthermore, the illustrative embodiments described above can be appropriately combined without causing inconsistency in the operational details.

8. Effect

As described earlier, the advertisement server device 200 according to the embodiment includes the delivering unit 234, which delivers control information to the terminal device 100 that includes the display unit 130. The control information according to the embodiment makes the terminal device 100 to perform a sequence of display control for controlling the display format of an advertising content having a bigger display size than the size of the display unit 130.

In this way, the advertisement server device 200 according to the embodiment ensures that the advertising content is displayed to be bigger than the size of the display unit 130 in the terminal device 100. That enables the advertisement server device 200 according to the embodiment to make the user to gaze at the advertising content thereby boosting his or her interest in the advertising content. As a result, the advertising effectiveness of the concerned advertising content can be enhanced.

Moreover, the control information makes the terminal device 100 to further perform the following operations: obtaining information related to the browsing behavior of the user with respect to an advertising content; and sending the obtained information related to the browsing behavior to the advertisement server device 200 that calculates the charge amount according to the browsing behavior.

In this way, the advertisement server device 200 according to the embodiment ensures that information related to the browsing behavior of the user with respect to the advertising content is obtained; receives the information related to the browsing behavior; and calculates the charge amount according to the received browsing behavior. As a result, even when the advertising content is displayed to be bigger than the size of the display unit 130, the advertisement server device 200 can calculate a fair charge amount with respect to the advertiser.

Moreover, the control information makes the terminal device 100 to further perform the following operations: obtaining information related to the browsing behavior of the user with respect to an advertising content; and sending the obtained information related to the browsing behavior to the advertisement server device 200.

In this way, the advertisement server device 200 according to the embodiment ensures that information related to the browsing behavior of the user with respect to the advertising content is obtained; and receives the information related to the browsing behavior. With that, for example, the advertisement server device 200 can calculate the charge amount according to the received browsing behavior.

As the information related to the browsing behavior, the display rate is obtained that represents the ratio of the dimension of the advertising content, which is displayed on the display unit, with respect to the dimension of the entire advertising content.

In this way, as a result of obtaining the display rate, even when the advertising content is displayed to be bigger than the size of the display unit 130, the advertisement server device 200 according to the embodiment can calculate a fair charge amount with respect to the advertiser based on the display rate.

Moreover, as the information related to the browsing behavior, the visual confirmation rate is obtained that represents the dimension of the area in which the advertising content is visually confirmed as against the dimension of the entire advertising content.

In this way, as a result of obtaining the visual confirmation rate, even when the advertising content is displayed to be bigger than the size of the display unit 130, the advertisement server device 200 according to the embodiment can calculate a fair charge amount with respect to the advertiser based on the visual confirmation rate.

Furthermore, as the information related to the browsing behavior, the period of time for which the advertising content is displayed on the display unit 130 is obtained.

In this way, as a result of obtaining the period of time for which the advertising content is displayed on the display unit 130, the advertisement server device 200 according to the embodiment can calculate a fair charge amount with respect to the advertiser based on the display period.

Moreover, as the information related to the browsing behavior, information related to the user operations with respect to the advertising content is obtained.

In this way, the advertisement server device 200 according to the embodiment can calculate a fair charge amount with respect to the advertiser based on the information related to the user operations.

Furthermore, as the information related to the user operations, information related to the period of time for which the user performs operations with respect to the advertising content, which is displayed on the display unit 130, is obtained.

In this way, as a result of obtaining the period of time for which the user performs operations with respect to the advertising content displayed on the display unit 130, even when the advertising content is displayed to be bigger than the size of the display unit 130, the advertisement server device 200 according to the embodiment can calculate a fair charge amount with respect to the advertiser based on the operation period.

Moreover, as the information related to the user operations, the movement amount of the advertising content displayed on the display unit 130 is obtained or the movement speed of the advertising content displayed on the display unit 130 is obtained.

In this way, as a result of obtaining the movement amount of the advertising content displayed on the display unit 130 or obtaining the movement speed of the advertising content displayed on the display unit 130, even when the advertising content is displayed to be bigger than the size of the display unit 130, the advertisement server device 200 according to the embodiment can calculate a fair charge amount with respect to the advertiser based on the movement amount or the movement speed.

Meanwhile, in the advertisement server device 200 according to the embodiment, the delivering unit 234 delivers control information to the terminal device 100 that receives an advertising content along with a relevant content that has a smaller display size than the size of the display unit 130 and that is relevant to the advertising content. The display control performed according to the control information includes controlling the display format of the advertising content and the relevant content.

In this way, the advertisement server device 200 according to the embodiment controls the display format of the advertising content and the relevant content, thereby making it possible to enhance the usability with respect to the advertising content and to enrich the details of the advertising content.

Moreover, the display control is performed to display the relevant content in an overlapping manner on the advertising content and to display the relevant content within a predetermined screen on the display unit 130.

In this way, as a result of displaying the relevant content in an overlapping manner on the advertising content and in a fixed manner at a predetermined position on the display unit 130, the advertisement server device 200 according to the embodiment can display such information which is to be particularly brought to the attention of the user on the terminal screen on a constant basis, thereby enabling achieving enhancement in the advertisement effectiveness.

In the advertisement server device 200 according to the embodiment, the delivering unit 234 delivers control information to the terminal device 100 that, as the relevant content, receives a content for guiding the user to a predetermined position in the advertising content. The display control performed according to the control information includes displaying the relevant content in an overlapping manner on the advertising content in such a way that the user is guided to a predetermined position.

In this way, the advertisement server device 200 according to the embodiment displays the relevant content in an overlapping manner on the advertising content in such a way that the user is guided to a predetermined position in the advertising content. As a result, it becomes possible to guide the user to the predetermined position in the advertising content without leading the user wrong, thereby enabling achieving enhancement in the usability with respect to the advertising content.

Moreover, in the advertisement server device 200 according to the embodiment, the delivering unit 234 delivers control information to the terminal device 100 that, as the relevant content, receives a content related to buying information, or detailed information, or a coupon of the product related to the advertising content. The display control performed according to the control information includes displaying the relevant content in an overlapping manner on the advertising content.

In this way, as a result of displaying the content related to buying information, or detailed information, or a coupon in an overlapping manner, the advertisement server device 200 according to the embodiment can enrich the details of the advertising content.

The display control performed according to the control information includes displaying information indicating the position of the advertising content, which is displayed on the display unit 130, in an overlapping manner on the advertising content.

In this way, as a result of displaying the information indicating the position of the advertising content, which is displayed on the display unit 130, in an overlapping manner on the advertising content; the advertisement server device 200 according to the embodiment can prevent perplexing the user regarding the advertising content. That enables achieving enhancement in the usability with respect to the advertising content.

Furthermore, in the advertisement server device 200 according to the embodiment, the delivering unit 234 delivers control information to the terminal device 100 that receives the advertising content and information related to the initial display position of the advertising content. The display control performed according to the control information includes displaying the advertising content based on the initial display position.

In this way, as a result of displaying the advertising content based on the initial display position that is received; regarding the positions in the advertising content that are believed to be of interest to the user, the advertisement server device 200 according to the embodiment can force the user to visually confirm those positions thereby enabling achieving enhancement in the advertisement effectiveness.

The display control performed according to the control information includes displaying a predetermined webpage in a transparently overlapping manner on the advertising content.

In this way, as a result of displaying a predetermined webpage in a transparently overlapping manner on the advertising content, the advertisement server device 200 according to the embodiment can make the user to pay attention to the advertising content as a natural extension to browsing the webpage. That enables achieving enhancement in the advertisement effectiveness.

The display control performed according to the control information includes moving an advertising content toward a predetermined position in that advertising content.

In this way, as a result of moving the advertising content toward a predetermined position in that advertising content, for example, the advertisement server device 200 according to the embodiment can force the user to visually confirm a particular position thereby enabling achieving enhancement in the advertisement effectiveness.

The advertisement server device 200 according to the embodiment includes the submission receiving unit 231 that receives an advertising content, which is displayed to be bigger than the size of the display unit 130, and receives bid information of the advertising content; includes the determining unit 233 that, based on the bid information received by the submission receiving unit 231, determines the sequence of display on the display unit 130 according to the movement operation; and includes the delivering unit 234 that delivers the advertising contents determined by the determining unit 233 to the terminal device 100 in such a way that the advertising contents are displayed according to the sequence of display determined by the determining unit 233.

As a result, the advertisement server device 200 according to the embodiment can display the advertising contents according to the bid information.

In the advertisement server device 200, the submission receiving unit 231 receives, as the bid information, the price per unit pixel count in the advertising content or the price per unit pixel count in the advertising content and the size of the advertising content at the time of being displayed on the display unit 130.

With that, for example, higher the bid unit price of an advertising content or greater the size of an advertising content, the more it becomes possible for the advertisement server device 200 according to the embodiment to display that advertising content in an easy-to-visually-confirm manner for the user.

In the advertisement server device 200 according to the embodiment, the delivering unit 234 delivers, to the terminal device 100, the advertising contents and the sequence of display thereof as determined by the determining unit 233.

As a result, the advertisement server device 200 according to the embodiment can display the advertising contents according to the bid information.

Moreover, in the advertisement server device 200 according to the embodiment, the delivering unit 234 delivers the advertising contents and the sequence of display thereof as determined by the determining unit 233 to a device that delivers advertising contents and a webpage in which the advertising contents are put to be displayed according to the sequence of display determined by the determining unit 233.

As a result, the advertisement server device 200 according to the embodiment can display the advertising contents according to the bid information.

In the advertisement server device 200 according to the embodiment, every time an advertising content becomes a target for display on the display unit 130, the delivering unit 234 receives a request for that advertising content from the terminal device 100, and delivers the advertising content in response to the received request.

In this way, instead of receiving at once the advertising contents determined by the determining unit 233; the advertisement server device 200 according to the embodiment receives only the advertisement corresponding to the advertisement request. That enables achieving reduction in the processing load attributed to the volume of the advertising contents.

Meanwhile, the terminal device 100 according to the embodiment includes the receiving unit 142 that receives control information, which makes the terminal device 100 to perform display control for controlling the display format of an advertising content having a bigger display size than the size of the display unit 130.

In this way, as a result of displaying an advertising content to be bigger than the size of the display unit 130, the terminal device 100 can make the user to gaze at the advertising content thereby boosting his or her interest in the advertising content. That enables achieving enhancement in the advertisement effectiveness.

Herein, although certain embodiments of the invention are described in detail with reference to the accompanying drawings, the appended claims are not to be thus limited but are to be construed as embodying all modifications and alternative constructions that may occur to one skilled in the art that fairly fall within the basic teaching herein set forth.

Moreover, the terms “section”, “module”, and “unit” used in the explanation can alternatively be read as terms “means” or “circuit”. For example, a requesting unit can be read as a requesting means or a requesting circuit.

Thus, according to an aspect of the embodiment, it becomes possible to enhance the advertisement effectiveness of advertising contents.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A delivery device comprising a delivering unit that delivers control information to a terminal device which includes a display unit, wherein
the control information makes the terminal device to perform display control for controlling display format of an advertising content having a bigger display size than size of the display unit.

2. The delivery device according to claim 1, wherein the control information further makes the terminal device to perform
an obtaining operation for obtaining information related to browsing behavior of a user with respect to the advertising content, and
a sending operation for sending information related to the browsing behavior as obtained in the obtaining operation to a predetermined device that calculates a charge amount according to the browsing behavior.

3. The delivery device according to claim 1, wherein the control information further makes the terminal device to perform
an obtaining operation for obtaining information related to browsing behavior of a user with respect to the advertising content, and
a sending operation for sending information related to the browsing behavior as obtained in the obtaining operation to a predetermined device that delivers the advertising content.

4. The delivery device according to claim 2, wherein the obtaining operation includes obtaining, as information related to the browsing behavior, a display rate that represents ratio of dimension of the advertising content, which is displayed on the display unit, with respect to dimension of the advertising content in entirety.

5. The delivery device according to claims 2, wherein the obtaining operation includes obtaining, as information related to the browsing behavior, a visual confirmation rate that represents dimension of a visual confirmation area, in which the user visually confirms the advertising content, as against dimension of the advertising content in entirety.

6. The delivery device according to claims 2, wherein the obtaining operation includes obtaining, as information related to the browsing behavior, a period of time for which the advertising content is displayed on the display unit.

7. The delivery device according to claims 2, wherein the obtaining operation includes obtaining, as information related to the browsing behavior, information related to an operation performed by the user with respect to the advertising content.

8. The delivery device according to claim 7, wherein the obtaining operation includes obtaining, as information related to an operation performed by the user, a period of time for which the user performs an operation with respect to the advertising content displayed on the display unit.

9. The delivery device according to claim 7, wherein the obtaining operation includes obtaining, as information related to an operation performed by the user, a movement amount of the advertising content displayed on the display unit or a movement speed of the advertising content displayed on the display unit.

10. The delivery device according to claims 1, wherein the delivering unit delivers the control information to the terminal device, which receives the advertising content along with a relevant content which has a smaller display size than the size of the display unit and which is associated to the advertising content, and
the display control includes controlling display format of the advertising content and the relevant content.

11. The delivery device according to claim 10, wherein the display control includes displaying the relevant content in an overlapping manner on the advertising content and displaying the relevant content inside screen of the display unit.

12. The delivery device according to claim 10, wherein
the delivering unit delivers the control information to the terminal device that receives, as the relevant content, a content for guiding the user to a predetermined position in the advertising content, and
the display control includes displaying the relevant content in an overlapping manner on the advertising content in such a way that the user is guided to the predetermined position.

13. The delivery device according to any claims 10, wherein
the delivering unit delivers the control information to the terminal device that receives, as the relevant content, a content related to buying information, or detailed information, or a coupon of product related to the advertising content, and
the display control includes displaying the relevant content in an overlapping manner on the advertising content.

14. The delivery device according to claims 1, wherein the display control includes displaying, in an overlapping manner on the advertising content, information indicating position of the advertising content displayed on the display unit.

15. The delivery device according to claims 1, wherein
the delivering unit delivers the control information to the terminal device, which receives the advertising content along with information related to initial display position of the advertising content, and
the display control includes displaying the advertising content based on the initial display position.

16. The delivery device according to claims 1, wherein the display control includes displaying a predetermined webpage in a transparently overlapping manner on the advertising content.

17. The delivery device according to claims 1, wherein the display control includes moving the advertising content toward a predetermined position in the advertising content.

18. An advertisement device comprising:
a submission receiving unit that receives an advertising content, which is displayed to be bigger than size of a display unit of a terminal device, and bid information of the advertising content;
a determining unit that, based on the bid information received by the submission receiving unit, determines an advertising content to be delivered and a sequence of display in which the advertising content to be delivered is to be displayed on the display unit; and
a delivering unit that delivers the advertising content determined by the determining unit to the terminal device in such a way that the advertising content is displayed in the sequence of display.

19. The advertisement device according to claim 18, wherein, as the bid information, the submission receiving unit receives a price per unit pixel count in the advertising content or receives a price per unit pixel count in the advertising content and size of the advertising content at time of being displayed on the display unit.

20. The advertisement device according to claim 18, wherein the delivering unit delivers, to the terminal device, the advertising content and the sequence of display as determined by the determining unit.

21. The advertisement device according to claim 18, wherein the delivering unit delivers the advertising content and the sequence of display as determined by the determining unit to a device that delivers the advertising content along with a webpage in which the advertising content is put to be displayed according to the sequence of display.

22. The advertisement device according to claim 18, wherein, every time an advertising content becomes a target for display on the display unit, when a request for concerned advertising content is received from the terminal device, the delivering unit delivers concerned advertising content in response to the received request.

23. A terminal device comprising a receiving unit that receives control information, wherein
the control information makes the terminal device to perform display control for controlling display format of an advertising content having a bigger display size than size of a display unit of the terminal device.

24. A delivery method performed by a computer, comprising delivering control information to a terminal device which includes a display unit, wherein
the control information makes the terminal device to perform display control for controlling display format of an advertising content having a bigger display size than size of the display unit.

25. A non-transitory computer readable storage medium including programmed instructions, wherein the instructions, when executed by a terminal device, cause the terminal device to receive control information, wherein
the control information makes the terminal device to perform display control for controlling display format of an advertising content having a bigger display size than size of a display unit of the terminal device.
